(19) United States
(12) Patent Application Publication
(10) Pub. No.: US 2026/0051011 A1
(43) Pub. Date: Feb. 19, 2026

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: PANASONIC INTELLECTUAL PROPERTY MANAGEMENT CO., LTD., OSAKA (JP)

(72) Inventor: Shinichiro HAMADA, Osaka (JP)

(21) Appl. No.: 19/368,383

(22) Filed: Oct. 24, 2025

Related U.S. Application Data
(63) Continuation of application No. PCT/JP2024/013040, filed on Mar. 29, 2024.

(30) Foreign Application Priority Data
Apr. 27, 2024 (JP) 2023-073589

(51) Int. Cl. G06Q 50/40

(52) U.S. Cl. CPC G06Q 50/40

(57) ABSTRACT

An information processing method by a transportation plan creation server includes: acquiring a transportation request including a desired boarding date/time of a new customer who desires to be transported by a vehicle; acquiring an existing transportation plan including a boarding date/time and a disembark date/time of an existing customer; calculating at least one of boarding delay time and disembark delay time indicating time delayed from at least one of a scheduled boarding date/time and a scheduled disembark date/time of one existing customer in the existing transportation plan by incorporating the transportation request into the existing transportation plan; and outputting at least one of the boarding delay time and the disembark delay time.

### FIELD OF INVENTION

The present disclosure relates to a technique of creating a transportation plan for transporting a plurality of customers by a plurality of vehicles.

### BACKGROUND ART

Conventionally, demand-responsive transport by a bus (demand bus) is known. In the demand bus, like a taxi, an operation route is determined from a transportation request of a customer. However, unlike a taxi, the demand bus allows a plurality of customers to ride together. Since only a necessary route is operated when necessary, and the route is shared by a plurality of customers, transportation efficiency is improved, and a fare is inexpensive.

The demand bus accepts the transportation request in real time. That is, a new customer transmits the transportation request to a demand bus operating company immediately before a desired boarding date/time. Upon receiving the transportation request, the demand bus operating company needs to insert the boarding location and the disembark location of the new customer into the existing transportation plan of the demand bus in operation.

There are roughly two types of methods for modifying an existing transportation plan. One of the methods is a method (hereinafter also referred to as a detour insertion method) of inserting a boarding location of a new customer in the middle of an existing transportation plan or inserting both a boarding location and a disembark location of a new customer in the middle of an existing transportation plan. The other method is a method of inserting both the boarding location and the disembark location of the new customer at the end of the existing transportation plan (hereinafter also referred to as a last insertion method).

In a case where the last insertion method is used to modify the existing transportation plan, the operation is the same as the operation of a taxi, there is no or little effect of route sharing, and transportation efficiency may not be improved. Therefore, the former detour insertion method is basically used to modify the existing transportation plan (see, for example, Non-Patent Literature 1 and Non-Patent Literature 2).

However, in the above-described conventional technique, presenting delay time generated by incorporating the transportation request of the new customer into the existing transportation plan to an existing customer assigned to the existing transportation plan is not considered, and further improvement is required.

Non-Patent Literature 1: Hideyuki Nakashima et al., “Smart Access Vehicle System: Implementation and Evaluation of a Vehicle Operation System for Demand Responsive Public Transportation”, Journal of Information Processing Society of Japan, Vol. 57, No. 4, April 2016, p. 1290-1302

Non-Patent Literature 2: Nakashima Hideyuki et al., “One Cycle of Smart Access Vehicle Service Development”, Serviceology for Designing the Future (Springer), 2016, 247-262

### SUMMARY OF THE INVENTION

The present disclosure has been made to solve the above problem, and an object of the present disclosure is to provide a technique capable of presenting, to an existing customer assigned to an existing transportation plan, delay time generated by incorporating a transportation request of a new customer into the existing transportation plan.

An information processing method according to the present disclosure is an information processing method in a computer, the method including: acquiring a transportation request including a desired boarding date/time of a new customer who desires to be transported by a vehicle; acquiring an existing transportation plan including a boarding date/time and a disembark date/time of an existing customer; calculating at least one of boarding delay time and disembark delay time indicating time delayed from at least one of a scheduled boarding date/time and a scheduled disembark date/time of one existing customer in the existing transportation plan by incorporating the transportation request into the existing transportation plan; and outputting at least one of the boarding delay time and the disembark delay time.

According to the present disclosure, it is possible to present, to an existing customer assigned an existing transportation plan, delay time generated by incorporating a transportation request of a new customer into the existing transportation plan.

### BRIEF DESCRIPTION OF THE DRAWINGS

FIG. 1 is a diagram illustrating an overall configuration of a vehicle dispatch management system in an embodiment of the present disclosure.

FIG. 2 is a diagram illustrating an example of bus stop timetable data in the present embodiment.

FIG. 3 is a diagram illustrating an example of inter-bus stop distance table data in the present embodiment.

FIG. 4 is a diagram illustrating an example of vehicle definition data in the present embodiment.

FIG. 5 is a diagram illustrating an example of vehicle delay time data in the present embodiment.

FIG. 6 is a flowchart for describing an operation of a transportation request receiver of a transportation plan creation server in an embodiment of the present disclosure.

FIG. 7 is a first flowchart for describing the operation of the transportation plan creator of the transportation plan creation server in an embodiment of the present disclosure.

FIG. 8 is a second flowchart for describing the operation of the transportation plan creator of the transportation plan creation server in an embodiment of the present disclosure.

FIG. 9 is a schematic diagram for describing processing of listing an insertion point pair group by a transportation plan improver in the present embodiment.

FIG. 10 is a flowchart for describing transportation plan evaluation processing of the transportation plan creation server in the present embodiment.

FIG. 11 is a schematic diagram for describing processing of calculating a scheduled departure date/time by a transportation plan evaluator in the present embodiment.

FIG. 12 is a flowchart for describing an operation of a vehicle dynamics monitor of the transportation plan creation server in an embodiment of the present disclosure.

FIG. 13 is a flowchart for describing a customer travel schedule transmission operation of a travel schedule transmitter of the transportation plan creation server in an embodiment of the present disclosure.

FIG. 14 is a diagram illustrating an example of a transportation request input screen displayed on a customer terminal in the present embodiment.

FIG. 15 is a diagram illustrating an example of a travel schedule notification screen displayed on the customer terminal in the present embodiment.

FIG. 16 is a first flowchart for describing an operation of the travel schedule transmitter of the transportation plan creation server in a first modification of an embodiment of the present disclosure.

FIG. 17 is a second flowchart for describing the operation of the travel schedule transmitter of the transportation plan creation server in the first modification of an embodiment of the present disclosure.

FIG. 18 is a diagram illustrating an example of the travel schedule notification screen displayed on the customer terminal in the first modification of the present embodiment.

FIG. 19 is a diagram illustrating an example of the travel schedule notification screen displayed on the customer terminal in a second modification of the present embodiment.

FIG. 20 is a diagram illustrating an example of the travel schedule notification screen displayed on the customer terminal in a third modification of the present embodiment.

FIG. 21 is a diagram illustrating an example of the travel schedule notification screen displayed on the customer terminal in a fourth modification of the present embodiment.

FIG. 22 is a diagram illustrating an example of the travel schedule notification screen displayed on the customer terminal in a fifth modification of the present embodiment.

FIG. 23 is a diagram illustrating an example of the travel schedule notification screen displayed on the customer terminal in a sixth modification of the present embodiment.

FIG. 24 is a flowchart for describing a vehicle travel schedule transmission operation of the travel schedule transmitter of the transportation plan creation server in an embodiment of the present disclosure.

FIG. 25 is a diagram illustrating an example of a travel schedule notification screen displayed on a vehicle terminal in the present embodiment.

FIG. 26 is a diagram illustrating an example of the travel schedule notification screen displayed on the vehicle terminal in a seventh modification of the present embodiment.

### DETAILED DESCRIPTION

### (Knowledge Underlying Present Disclosure)

In a case where the existing transportation plan is modified by the detour insertion method described above, there is a possibility that the boarding date/time and the disembark date/time of the customer already allocated to the demand bus in operation are delayed. As a result, there is a possibility that the delay from the boarding date/time and the disembark date/time is normalized. By repeating an experience that the demand bus does not arrive at the originally scheduled time, the customer not only feels strong dissatisfaction but also becomes more distrustful than toward other punctual transportation infrastructures.

As described above, in principle of the demand bus, in order to create an efficient transportation plan including a new customer, it is impossible to avoid a delay of the boarding date/time and the disembark date/time of the existing customer.

Therefore, it is necessary to obtain reasonable understanding of the generated delay from the existing customer assigned the existing transportation plan by presenting, to the existing customer assigned to the existing transportation plan, delay time generated by inserting a boarding location and a disembark location of the new customer into the existing transportation plan.

In order to solve the above problem, a technique below is disclosed.
(1) An information processing method according to one aspect of the present disclosure is an information processing method in a computer, the method including: acquiring a transportation request including a desired boarding date/time of a new customer who desires to be transported by a vehicle; acquiring an existing transportation plan including a boarding date/time and a disembark date/time of an existing customer; calculating at least one of boarding delay time and disembark delay time indicating time delayed from at least one of a scheduled boarding date/time and a scheduled disembark date/time of one existing customer in the existing transportation plan by incorporating the transportation request into the existing transportation plan; and outputting at least one of the boarding delay time and the disembark delay time.

According to this configuration, by incorporating the transportation request into the existing transportation plan, at least one of the boarding delay time and the disembark delay time indicating the time delayed from at least one of the scheduled boarding date/time and the scheduled disembark date/time of the one existing customer in the existing transportation plan is calculated, and at least one of the calculated boarding delay time and disembark delay time is outputted.

Therefore, since at least one of the boarding delay time and the disembark delay time indicating the time delayed from at least one of the scheduled boarding date/time and the scheduled disembark date/time of the one existing customer in the existing transportation plan is presented to the one existing customer, the delay time generated by incorporating the transportation request of the new customer into the existing transportation plan can be presented to the existing customer assigned to the existing transportation plan. As a result, reasonable understanding of the generated delay time can be obtained from the existing customer assigned to the existing transportation plan.
(2) In the information processing method according to (1), the transportation request may further include customer identification information, a boarding location, and an disembark location.

According to this configuration, the boarding location and the disembark location of the new customer can be inserted into the existing transportation plan.
(3) In the information processing method according to (1) or (2), the existing transportation plan may be a plan in which boarding locations and disembark locations of a plurality of existing customers are arranged in chronological order in a plurality of vehicles, and the transportation request may be incorporated into the existing transportation plan by inserting the boarding location and the disembark location of the new customer into the existing transportation plan based on the transportation request.

According to this configuration, it is possible to present, to the existing customer assigned to the existing transportation plan, the delay time generated by inserting the boarding location and the disembark location of the new customer into the existing transportation plan.
(4) The information processing method according to any one of (1) to (3) may further include: calculating movement delay time that is a difference between measured movement time required for one vehicle that the one existing customer boards to move from a first spot to a second spot included in the existing transportation plan, and scheduled movement time between the first spot and the second spot, the scheduled movement time having been set in advance, in which in the output of at least one of the boarding delay time and the disembark delay time, the movement delay time may be further outputted.

According to this configuration, the movement delay time is calculated which is the difference between the measured movement time required for one vehicle that the one existing customer boards to move from the first spot to the second spot included in the existing transportation plan, and the scheduled movement time between the first spot and the second spot that is set in advance, and the movement delay time is further outputted together with at least one of the boarding delay time and the disembark delay time.

The movement delay time is not delay time generated by inserting the boarding location and the disembark location of the new customer into the existing transportation plan, but delay time generated by change in a traffic condition such as a traffic jam. Therefore, it is possible to further present, to the existing customer, the delay time generated by change in the traffic condition such as a traffic jam, separately from the delay time generated by incorporating the transportation request of the new customer into the existing transportation plan.
(5) The information processing method according to any one of (1) to (4) may further include: acquiring boarding delay upper limit time indicating an upper limit of the boarding delay time from the scheduled boarding date/time; and calculating boarding delay allowable time that is obtained by subtracting the boarding delay time from the boarding delay upper limit time, in which in the output of at least one of the boarding delay time and the disembark delay time, the boarding delay allowable time may be further outputted with the boarding delay time.

According to this configuration, the boarding delay allowable time obtained by subtracting the boarding delay time from the boarding delay upper limit time is presented to the existing customer, so that the existing customer can know how much time until boarding the vehicle is likely to be delayed from now.
(6) The information processing method according to any one of (1) to (5) may further include: acquiring disembark delay upper limit time indicating an upper limit of the disembark delay time from the scheduled disembark date/time; and calculating disembark delay allowable time that is obtained by subtracting the disembark delay time from the disembark delay upper limit time, in which in the output of at least one of the boarding delay time and the disembark delay time, the disembark delay allowable time may be further outputted with the disembark delay time.

According to this configuration, the disembark delay allowable time obtained by subtracting the disembark delay time from the disembark delay upper limit time is presented to the existing customer, so that the existing customer can know how much time from disembark from the vehicle is likely to be delayed from now.
(7) The information processing method according to any one of (1) to (6) may further include: acquiring a travel schedule request for requesting a travel schedule of the one existing customer from a terminal of the one existing customer, in which in the output of at least one of the boarding delay time and the disembark delay time, a boarding location of the one existing customer, a scheduled boarding date/time of the one existing customer, the boarding delay time of the one existing customer, an disembark location of the one existing customer, a scheduled disembark date/time of the one existing customer, and the disembark delay time of the one existing customer in a new transportation plan in which the transportation request is incorporated into the existing transportation plan may be outputted to the terminal of the one existing customer.

According to this configuration, it is possible to present, to the one existing customer who has requested the travel schedule, the boarding location of the one existing customer, the scheduled boarding date/time of the one existing customer, the boarding delay time of the one existing customer, the disembark location of the one existing customer, the scheduled disembark date/time of the one existing customer, and the disembark delay time of the one existing customer in the new transportation plan.
(8) The information processing method according to (7) may further include: determining whether or not the one existing customer has already boarded the vehicle at a current date/time, in which in the output of at least one of the boarding delay time and the disembark delay time, in a case where it is determined that the one existing customer has already boarded the vehicle at the current date/time, information indicating that the one existing customer has already boarded the vehicle may be further outputted to the terminal of the one existing customer.

According to this configuration, it is possible to present whether or not the one existing customer has already boarded in the terminal of the one existing customer. In addition, in the case where the one existing customer has already boarded, the presentation of the boarding delay time of the one existing customer can be omitted.
(9) The information processing method according to any one of (1) to (6) may further include: acquiring a travel schedule request for requesting a travel schedule of the one existing customer from a terminal of the one existing customer, in which in the output of at least one of the boarding delay time and the disembark delay time, boarding locations of all existing customers and the new customer of the vehicle that the one existing customer boards, scheduled boarding date/time of all the existing customers and the new customer, the boarding delay time of all the existing customers and the new customer, disembark locations of the all the existing customers and the new customer, and scheduled disembark date/time of all the existing customers and the new customer, and the disembark delay time of all the existing customers and the new customer in a new transportation plan in which the transportation request is incorporated into the existing transportation plan may be outputted to the terminal of the one existing customer.

According to this configuration, it is possible to present, to one existing customer, not only the boarding location, the scheduled boarding date/time, the boarding delay time, the disembark location, the scheduled disembark date/time, and the disembark delay time of the one existing customer who has requested the travel schedule but also the boarding locations, the scheduled boarding date/time, the boarding delay times, the disembark locations, the scheduled disembark date/time, and the disembark delay times of all the existing customers and the new customer of the vehicle that the one existing customer boards. As a result, the one existing customer who has requested the travel schedule can grasp the delay in the entire travel schedule of the vehicle, and can deepen understanding of the delay.
(10) The information processing method according to (9) may further include: calculating a time difference as measured movement time, the time difference being a difference between each of departure date/time of the vehicle at a plurality of stop places that are places where other existing customers who board the same vehicle as the one existing customer boarded and disembarked from the vehicle in the past, and a departure date/time of the vehicle at a stop place one before each of the plurality of stop places; acquiring scheduled movement time set in advance, the scheduled movement time being time between each of the plurality of stop places and the stop place one before each of the plurality of stop places; and calculating movement delay time that is a difference between the measured movement time and the scheduled movement time between the respective stop places among the plurality of stop places, in which in the output of at least one of the boarding delay time and the disembark delay time, the movement delay time between the respective stop places among the plurality of stop places in the past may be further outputted to the terminal of the one existing customer.

The movement delay time is not delay time generated by inserting the boarding location and the disembark location of the new customer into the existing transportation plan, but delay time generated by change in a traffic condition such as a traffic jam. Therefore, it is possible to further present, to the existing customer, the delay time generated between the respective stop places by change in the traffic condition such as a traffic jam, separately from the delay time generated by incorporating the transportation request of the new customer into the existing transportation plan.
(11) The information processing method according to (9), in the output of at least one of the boarding delay time and the disembark delay time, boarding locations of all existing customers of the vehicle that the one existing customer boards, scheduled boarding date/time of all the existing customers, the boarding delay time of all the existing customers, disembark locations of all the existing customers, scheduled disembark date/time of all the existing customers, and the disembark delay time of all the existing customers in the existing transportation plan may be further outputted to the terminal of the one existing customer.

According to this configuration, it is possible to present, to the existing customer, the travel schedule of the existing transportation plan before change and the travel schedule of the new transportation plan after change.

Further, the present disclosure can be realized not only as the information processing method for executing the characteristic processing as described above, but also as an information processing device or the like having a characteristic configuration corresponding to characteristic processing executed by the information processing method. In addition, it is also possible to realize a computer program that causes a computer to execute the characteristic processing included in the above-described information processing method. Therefore, an effect similar to the effect in the above information processing method can also be achieved by another aspect described below.
(12) An information processing device according to another aspect of the present disclosure includes: a transportation request acquisition part that acquires a transportation request including a desired boarding date/time of a new customer who desires to be transported by a vehicle; an existing transportation plan acquisition part that acquires an existing transportation plan including a boarding date/time and a disembark date/time of an existing customer; a calculator that calculates at least one of boarding delay time and disembark delay time indicating time delayed from at least one of a scheduled boarding date/time and a scheduled disembark date/time of one existing customer in the existing transportation plan by incorporating the transportation request into the existing transportation plan; and an output part that outputs at least one of the boarding delay time and the disembark delay time.
(13) An information processing program according to another aspect of the present disclosure causes a computer to function so as to: acquire a transportation request including a desired boarding date/time of a new customer who desires to be transported by a vehicle; acquire an existing transportation plan including a boarding date/time and a disembark date/time of an existing customer; calculate at least one of boarding delay time and disembark delay time indicating time delayed from at least one of a scheduled boarding date/time and a scheduled disembark date/time of one existing customer in the existing transportation plan by incorporating the transportation request into the existing transportation plan; and output at least one of the boarding delay time and the disembark delay time.
(14) A non-transitory computer-readable recording medium according to another aspect of the present disclosure records an information processing program, the information processing program causing a computer to function so as to: acquire a transportation request including a desired boarding date/time of a new customer who desires to be transported by a vehicle; acquire an existing transportation plan including a boarding date/time and a disembark date/time of an existing customer; calculate at least one of boarding delay time and disembark delay time indicating time delayed from at least one of a scheduled boarding date/time and a scheduled disembark date/time of one existing customer in the existing transportation plan by incorporating the transportation request into the existing transportation plan; and output at least one of the boarding delay time and the disembark delay time.

Hereinafter, embodiments of the present disclosure will be described with reference to the accompanying drawings. Each of embodiments described below illustrates a specific example of the present disclosure. Numerical values, shapes, constituent elements, steps, order of steps, and the like of the embodiment below are merely examples, and do not intend to limit the present disclosure. A constituent element not described in an independent claim representing a highest concept among constituent elements in the embodiments below is described as an optional constituent element. In all the embodiments, respective contents can be combined.

### EMBODIMENTS

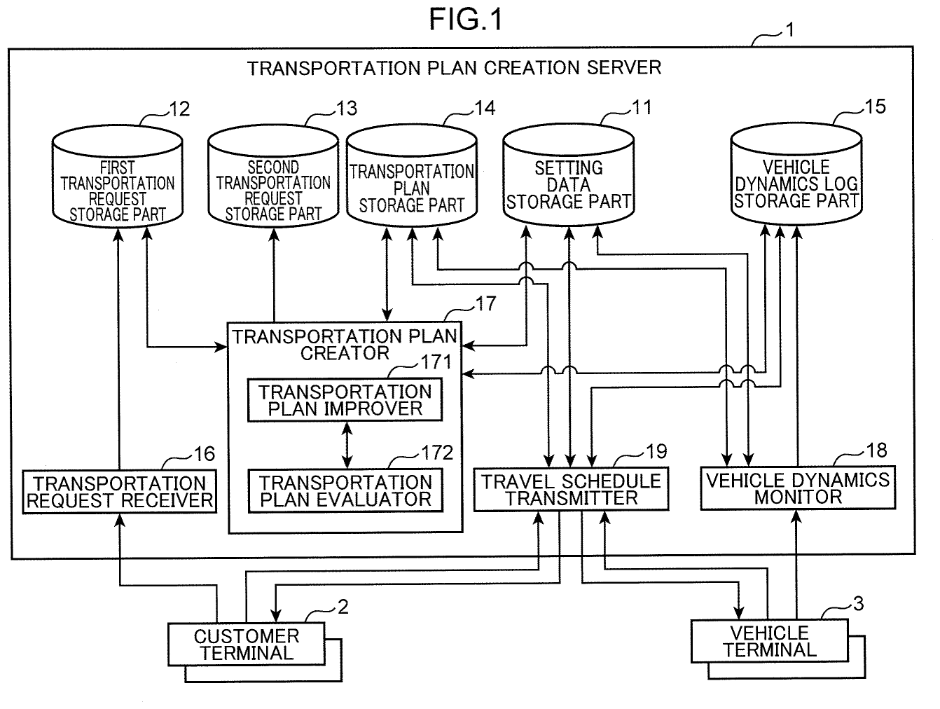

FIG. 1 is a diagram illustrating an overall configuration of a vehicle dispatch management system in the embodiment of the present disclosure.

The vehicle dispatch management system illustrated in FIG. 1 includes a transportation plan creation server 1, a plurality of customer terminals 2, and a plurality of vehicle terminals 3.

The customer terminal 2 is a smartphone, a tablet computer, or a personal computer, for example, and is carried by a customer who desires to be transported by a vehicle. The vehicle is, for example, a bus that transports a plurality of persons. The customer terminal 2 receives an input of a boarding location, a disembark location, and a desired boarding date/time by the customer, and transmits transportation request data including a customer ID, the boarding location, the disembark location, and the desired boarding date/time to the transportation plan creation server 1. The customer ID is customer identification information for identifying a customer, and is stored in advance in a memory of the customer terminal 2. The basic configuration of each of the plurality of customer terminals 2 is the same.

In the present embodiment, an operation route and a stop place (bus stop) of the vehicle are determined in advance. The customer selects a boarding location and a disembark location from a plurality of stop places set in advance on the operation route. The customer inputs the date and time of boarding the vehicle.

In the present embodiment, the boarding location and the disembark location are predetermined stop places (bus stops). However, the present disclosure is not limited to the places, and the boarding location and the disembark location may be arbitrary places specified by the customer. In this case, the customer may input the boarding location and the disembark location on a map displayed on the customer terminal 2, or may input an address, a facility name, or the like as the boarding location and the disembark location to the customer terminal 2.

The customer terminal 2 may receive customer travel schedule information indicating a travel schedule from boarding to disembark of the customer from the transportation plan creation server 1, and display the received customer travel schedule information.

The vehicle terminal 3 is, for example, a smartphone, a tablet computer, or a car navigation device mounted on a vehicle, and is carried by a driver who drives the vehicle. The vehicle terminal 3 may receive the individual transportation plan (vehicle travel schedule information) of the vehicle from the transportation plan creation server 1 and display the received individual transportation plan (vehicle travel schedule information). The vehicle terminal 3 presents the received individual transportation plan to the driver. The driver moves the vehicle in accordance with the presented individual transportation plan, and boards and disembarks the plurality of customers. The basic configuration of each of the plurality of vehicle terminals 3 is the same.

The transportation plan creation server 1 creates a transportation plan for transporting a plurality of customers by a plurality of vehicles. The transportation plan creation server 1 is communicably connected to the plurality of customer terminals 2 and the plurality of vehicle terminals 3 via a network. The network is the Internet, for example.

The individual transportation plan indicates an order of transportation in which boarding locations and disembark locations of a plurality of customers allocated to individual vehicles are arranged in time series. The individual transportation plan includes a scheduled boarding date/time and a scheduled disembark date/time of each customer. The transportation plan indicates a set of individual transportation plans.

The transportation plan creation server 1 includes a setting data storage part 11, a first transportation request storage part 12, a second transportation request storage part 13, a transportation plan storage part 14, a vehicle dynamics log storage part 15, a transportation request receiver 16, a transportation plan creator 17, a vehicle dynamics monitor 18, and a travel schedule transmitter 19.

The transportation plan creator 17 is implemented by a processor. The processor includes, for example, a central processing unit (CPU) or the like.

The setting data storage part 11, the first transportation request storage part 12, the second transportation request storage part 13, the transportation plan storage part 14, and the vehicle dynamics log storage part 15 are implemented by a memory. The memory includes, for example, a read only memory (ROM), an electrically erasable programmable read only memory (EEPROM), or the like.

The transportation request receiver 16, the vehicle dynamics monitor 18, and the travel schedule transmitter 19 are implemented by a processor and a communication module.

The setting data storage part 11 stores in advance bus stop timetable data, inter-bus stop distance table data, and vehicle definition data.

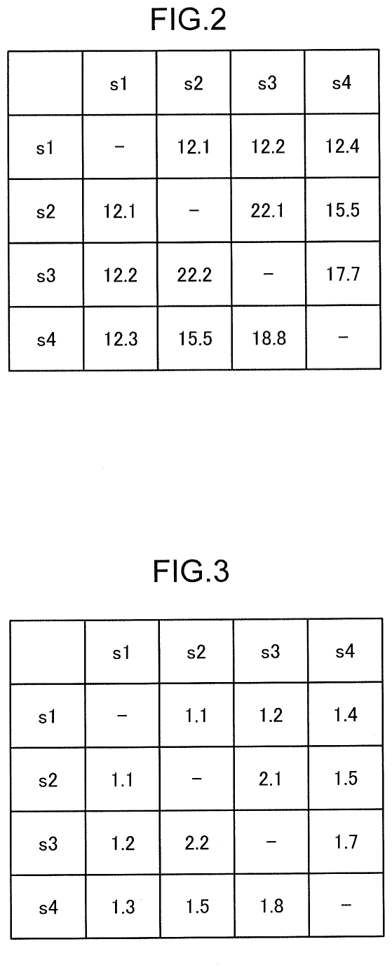

FIG. 2 is a diagram illustrating an example of the bus stop timetable data in the present embodiment.

The bus stop timetable data is data indicating time required for movement between bus stops (scheduled movement time). In the bus stop timetable data, the vertical axis represents bus stops s1, s2, s3, and s4 as movement sources, and the horizontal axis represents the bus stops s1, s2, s3, and s4 as movement destinations. The unit is, for example, a minute. The bus stop timetable data does not become a symmetric matrix due to the presence of one-way traffic, a difference in traffic volume, or the like. In the bus stop timetable data in the present embodiment, a fixed value is used regardless of a time period, a season, or the like, but a different value may be used for each time period or each season.

FIG. 3 is a diagram illustrating an example of the inter-bus stop distance table data in the present embodiment.

The inter-bus stop distance table data is data indicating a distance of a movement route between bus stops. In the inter-bus stop distance table data, the vertical axis represents the bus stops s1, s2, s3, and s4 as movement sources, and the horizontal axis represents the bus stops s1, s2, s3, and s4 as movement destinations. The unit is, for example, kilometers. The inter-bus stop distance table data does not become a symmetric matrix due to the presence of one-way traffic or the like. In the inter-bus stop distance table data in the present embodiment, a fixed value is used regardless of a time period, a season, or the like, but a different value may be used for each time period or each season.

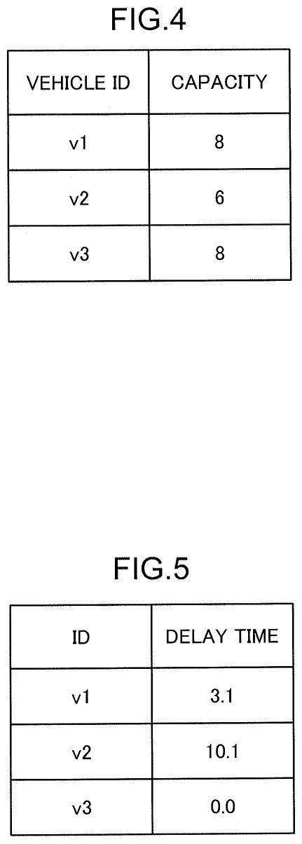

FIG. 4 is a diagram illustrating an example of the vehicle definition data in the present embodiment.

The vehicle definition data is data indicating a plurality of vehicle IDs for identifying a plurality of vehicles and a capacity of each vehicle. As illustrated in FIG. 4, in the present embodiment, the vehicle definition data includes three vehicle IDs of a first vehicle v1, a second vehicle v2, and a third vehicle v3. The vehicle definition data indicates that the capacity of the first vehicle v1 is eight, the capacity of the second vehicle v2 is six, and the capacity of the third vehicle v3 is eight.

The transportation request receiver 16 acquires a transportation request including a desired boarding date/time of a new customer who desires to be transported by the vehicle. The transportation request data may further include a customer ID, a boarding location, and a disembark location. The transportation request receiver 16 acquires transportation request data including the customer ID, the desired boarding date/time, the boarding location, and the disembark location from the customer terminal 2 of each of a plurality of customers who desires to be transported by the vehicle. The transportation request receiver 16 acquires transportation request data including the customer ID, the desired boarding date/time, the boarding location, and the disembark location from the customer terminal 2 of the new customer who desires to be transported by the vehicle. The transportation request receiver 16 receives the transportation request data transmitted by the customer terminal 2. The transportation request receiver 16 stores the received transportation request data in the first transportation request storage part 12.

The first transportation request storage part 12 stores transportation request data of a customer not allocated to the transportation plan.

The second transportation request storage part 13 stores transportation request data of a customer allocated to the transportation plan.

The vehicle dynamics monitor 18 receives bus stop departure log information from the vehicle terminal 3. The bus stop departure log information includes a vehicle ID, a bus stop ID, a customer ID of a customer who boards and disembarks at the bus stop, and a departure date/time of the bus stop. The vehicle terminal 3 transmits the bus stop departure log information to the transportation plan creation server 1 when the vehicle departs from the bus stop. The vehicle dynamics monitor 18 stores the received bus stop departure log information in the vehicle dynamics log storage part 15.

The vehicle dynamics monitor 18 acquires the individual transportation plan of the vehicle corresponding to the vehicle ID included in the bus stop departure log information from the transportation plan storage part 14. The vehicle dynamics monitor 18 calculates a time difference between the bus stop departure date/time one stop before included in the acquired individual transportation plan and the bus stop departure date/time of this time as a measured movement time. The vehicle dynamics monitor 18 acquires the scheduled movement time between the bus stop one stop before and the bus stop of this time from the bus stop timetable data of the setting data storage part 11. The vehicle dynamics monitor 18 adds a difference time obtained by subtracting the scheduled movement time from the measured movement time to an unplanned delay time of the vehicle in vehicle delay time data stored in the vehicle dynamics log storage part 15. Note that the difference value may be negative. In this case, the unplanned delay time of the vehicle in the vehicle delay time data decreases.

The vehicle dynamics monitor 18 receives vehicle state log information from the vehicle terminal 3. The vehicle state log information includes a vehicle ID, a current location of the vehicle, the number of customers who are currently on board in the vehicle, and current date/time. The current location of the vehicle is represented by latitude and longitude. The vehicle terminal 3 periodically transmits the vehicle state log information to the transportation plan creation server 1. The vehicle dynamics monitor 18 stores the received vehicle state log information in the vehicle dynamics log storage part 15.

The vehicle dynamics log storage part 15 stores the bus stop departure log information, the vehicle state log information, and the vehicle delay time data.

FIG. 5 is a diagram illustrating an example of the vehicle delay time data in the present embodiment.

The vehicle delay time data is data indicating the plurality of vehicle IDs for identifying the plurality of vehicles and the unplanned delay time of each vehicle. The unit of the delay time is, for example, a minute. The vehicle delay time data illustrated in FIG. 5 indicates that the unplanned delay time of the first vehicle v1 is 3.1 minutes, the unplanned delay time of the second vehicle v2 is 10.1 minutes, and the unplanned delay time of the third vehicle v3 is 0.0 minutes.

The transportation plan creator 17 periodically creates a transportation plan in which a plurality of customers is allocated to a plurality of vehicles on the basis of a plurality of sets of transportation request data. The transportation plan creator 17 stores the created transportation plan in the transportation plan storage part 14.

The transportation plan storage part 14 stores the transportation plan created by the transportation plan creator 17. The transportation plan storage part 14 stores an existing transportation plan in operation.

The transportation plan creator 17 acquires the existing transportation plan including the boarding date/time and the disembark date/time of an existing customer. The transportation plan creator 17 acquires the existing transportation plan that specifies the transportation route connecting the boarding location and the disembark location of the existing customer. The transportation plan creator 17 acquires, from the transportation plan storage part 14, the existing transportation plan in which the boarding locations and the disembark locations of a plurality of existing customers are arranged in time series for each of the plurality of vehicles. The transportation plan creator 17 creates a new transportation plan on the basis of the transportation request data. The transportation plan creator 17 creates a new transportation plan in which the boarding location and the disembark location of the new customer are inserted into the existing transportation plan on the basis of the desired boarding date/time, the boarding location, and the disembark location included in the transportation request data. The transportation plan creator 17 inserts the boarding location of the new customer in the existing transportation plan at either a first point before the disembark location of a last remaining existing customer, or a second point after the disembark location of the last remaining existing customer depending on whether a delay time from each of a scheduled boarding date/time and a scheduled disembark date/time of each of a plurality of existing customers exceeds a predetermined upper limit time when the boarding location of the new customer is inserted at the first point.

The transportation plan creator 17 outputs the created new transportation plan to the transportation plan storage part 14. The transportation plan creator 17 stores the created new transportation plan in the transportation plan storage part 14.

When the boarding location of the new customer is inserted at the first point, in a case where the delay time of each of the plurality of existing customers does not exceed the predetermined upper limit time, the transportation plan creator 17 inserts the boarding location of the new customer at the first point and inserts the disembark location of the new customer at the first point or the second point. When the boarding location of the new customer is inserted at the first point, in a case where the delay time of each of the plurality of existing customers exceeds the predetermined upper limit time, the transportation plan creator 17 inserts the boarding location and the disembark location of the new customer at the second point.

The transportation plan creator 17 acquires a boarding delay upper limit time indicating an upper limit of a boarding delay time indicating the delay time from the scheduled boarding date/time of the plurality of existing customers in the existing transportation plan, and a disembark delay upper limit time indicating an upper limit of a disembark delay time indicating the delay time from the scheduled disembark date/time of the plurality of existing customers in the existing transportation plan. The boarding delay upper limit time and the disembark delay upper limit time are predetermined times and are stored in advance in the memory. The boarding delay upper limit time is, for example, 15 minutes, and the disembark delay upper limit time is, for example, 20 minutes. The boarding delay upper limit time and the disembark delay upper limit time may be different from each other or may be the same. The boarding delay upper limit time and the disembark delay upper limit time may be set for each customer.

The transportation plan creator 17 acquires an unplanned delay time (movement delay time) which is a difference between the measured movement time required for each of the plurality of vehicles to move from a first spot to a second spot included in the existing transportation plan and the scheduled movement time between the first spot and the second spot set in advance. The unplanned delay time is stored in the vehicle dynamics log storage part 15.

When the boarding location of the new customer is inserted at the first point, the transportation plan creator 17 inserts the boarding location of the new customer at either the first point or the second point depending on whether the boarding delay time and the disembark delay time of each of the plurality of existing customers exceed a time obtained by adding the unplanned delay time (movement delay time) to the boarding delay upper limit time and a time obtained by adding the unplanned delay time (movement delay time) to the disembark delay upper limit time.

Specifically, when the boarding location of the new customer is inserted at the first point, in a case where the boarding delay time and the disembark delay time of each of the plurality of existing customers do not exceed the time obtained by adding the unplanned delay time (movement delay time) to the boarding delay upper limit time and the time obtained by adding the unplanned delay time (movement delay time) to the disembark delay upper limit time, the transportation plan creator 17 inserts the boarding location of the new customer at the first point and inserts the disembark location of the new customer at the first point or the second point. When the boarding location of the new customer is inserted at the first point, in a case where the boarding delay time and the disembark delay time of each of the plurality of existing customers exceed the time obtained by adding the unplanned delay time (movement delay time) to the boarding delay upper limit time and the time obtained by adding the unplanned delay time (movement delay time) to the disembark delay upper limit time, the transportation plan creator 17 inserts the boarding location and the disembark location of the new customer at the second point.

The transportation plan creator 17 may insert the boarding location of the new customer at either the first point or the second point depending on whether the boarding delay time and the disembark delay time of each of the plurality of existing customers exceed the boarding delay upper limit time and the disembark delay upper limit time when the boarding location of the new customer is inserted at the first point. In this case, when the boarding location of the new customer is inserted at the first point, in a case where the boarding delay time and the disembark delay time of each of the plurality of existing customers do not exceed the boarding delay upper limit time and the disembark delay upper limit time, the transportation plan creator 17 may insert the boarding location of the new customer at the first point and may insert the disembark location of the new customer to the first point or the second point. When the boarding location of the new customer is inserted at the first point, in a case where the boarding delay time and the disembark delay time of each of the plurality of existing customers exceed the boarding delay upper limit time and the disembark delay upper limit time, the transportation plan creator 17 may insert the boarding location and the disembark location of the new customer at the second point.

The transportation plan creator 17 includes a transportation plan improver 171 and a transportation plan evaluator 172.

The transportation plan improver 171 acquires the vehicle definition data from the setting data storage part 11. The transportation plan improver 171 acquires the existing transportation plan from the transportation plan storage part 14. The transportation plan improver 171 acquires the unplanned delay time of each of the plurality of vehicles included in the acquired existing transportation plan from the vehicle delay time data stored in the vehicle dynamics log storage part 15. The transportation plan improver 171 calculates an actual boarding delay upper limit time obtained by adding the unplanned delay time of each vehicle to the boarding delay upper limit time for each vehicle, and calculates an actual disembark delay upper limit time obtained by adding the unplanned delay time of each vehicle to the disembark delay upper limit time for each vehicle.

The transportation plan improver 171 acquires the transportation request data of one new customer from the first transportation request storage part 12. The transportation plan improver 171 lists, as an insertion point pair group, a plurality of insertion point pairs for inserting a boarding location and a disembark location included in the transportation request data of one new customer in the existing transportation plan. Here, the transportation plan improver 171 lists the insertion point pair groups satisfying a predetermined constraint condition. The predetermined constraint condition includes a first constraint condition that the insertion point of the boarding location is the same vehicle as the insertion point of the disembark location and is ahead of the insertion point of the disembark location in the existing transportation plan, a second constraint condition that the capacity of vehicles is not exceeded as a result of inserting the boarding location and the disembark location, and a third constraint condition that the delay time of the scheduled boarding date/time of each existing customer included in the existing transportation plan does not exceed the actual boarding delay upper limit time and the delay time of the scheduled disembark date/time of each existing customer included in the existing transportation plan does not exceed the actual disembark delay upper limit time as a result of inserting the boarding location and the disembark location. The transportation plan improver 171 lists the insertion point pair groups satisfying the first constraint condition, the second constraint condition, and the third constraint condition.

The transportation plan improver 171 creates a hypothetical transportation plan group in which a boarding location and a disembark location included in the transportation request data of one new customer are inserted into each of the listed insertion point pair groups. The transportation plan improver 171 outputs each of the hypothetical transportation plan group to the transportation plan evaluator 172, and acquires an evaluation value of each of the hypothetical transportation plan group and a scheduled departure date/time of each bus stop from the transportation plan evaluator 172. The transportation plan improver 171 stores the hypothetical transportation plan having a minimum evaluation value, the evaluation value of the hypothetical transportation plan, and the scheduled departure date/time of each bus stop in the memory as a current transportation plan, the evaluation value of the current transportation plan, and the scheduled departure date/time of each bus stop.

When there is no transportation request data of the new customer in the first transportation request storage part 12, the transportation plan improver 171 stores the current transportation plan, the evaluation value of the current transportation plan, and the scheduled departure date/time of each bus stop in the transportation plan storage part 14. At this time, the transportation plan improver 171 stores the scheduled boarding date/time and the scheduled disembark date/time of the customer newly incorporated in the transportation plan as an initial scheduled boarding date/time and an initial scheduled disembark date/time in association with the existing transportation plan.

The transportation plan evaluator 172 acquires the hypothetical transportation plan from the transportation plan improver 171. The transportation plan evaluator 172 calculates a total value of the transportation time of all the plurality of vehicles in the hypothetical transportation plan as an evaluation value. The transportation plan evaluator 172 may calculate a total value of a transportation distance of all the plurality of vehicles in the hypothetical transportation plan as an evaluation value.

The transportation plan evaluator 172 calculates the scheduled departure date/time of each bus stop of all the plurality of vehicles in the hypothetical transportation plan. The transportation plan evaluator 172 calculates a transportation time obtained by subtracting the current date/time from the scheduled departure date/time of the last disembark location included in the individual transportation plan of the hypothetical transportation plan, and calculates a total value of the transportation time of all the plurality of individual transportation plans in the hypothetical transportation plan as an evaluation value.

The transportation plan evaluator 172 outputs the calculated evaluation value of the hypothetical transportation plan and the scheduled departure date/time of each bus stop to the transportation plan improver 171.

The travel schedule transmitter 19 calculates at least one of the boarding delay time or the disembark delay time indicating the time delayed from at least one of the scheduled boarding date/time or the scheduled disembark date/time of the one existing customer in the existing transportation plan by incorporating the transportation request into the existing transportation plan. When the boarding location and the disembark location of the new customer are inserted into the existing transportation plan on the basis of the transportation request, the travel schedule transmitter 19 calculates at least one of the boarding delay time or the disembark delay time indicating the time delayed from at least one of the scheduled boarding date/time or the scheduled disembark date/time of the one existing customer in the existing transportation plan. The travel schedule transmitter 19 outputs at least one of the calculated boarding delay time or the calculated disembark delay time. The travel schedule transmitter 19 transmits at least one of the calculated boarding delay time or the calculated disembark delay time to the customer terminal 2.

The travel schedule transmitter 19 calculates the movement delay time which is a difference between the measured movement time required for one vehicle boarded by one existing customer to move from the first spot to the second spot included in the existing transportation plan and the scheduled movement time between the first spot and the second spot set in advance. The travel schedule transmitter 19 further outputs the movement delay time together with at least one of the boarding delay time or the disembark delay time. The travel schedule transmitter 19 transmits at least one of the calculated boarding delay time or the calculated disembark delay time and the movement delay time to the customer terminal 2.

The boarding delay time and the disembark delay time are also referred to as a planned delay time. The planned delay time is a delay time caused by inserting the boarding location and the disembark location of the new customer into the existing transportation plan. The movement delay time is also referred to as unplanned delay time. The unplanned delay time is a delay time caused by a change in a traffic condition or the like. A new transportation plan is created so that the planned delay time is within a predetermined upper limit time. While the vehicle is in operation, the planned delay time and the unplanned delay time are presented to the customer.

Since the unplanned delay time may occur not only in a demand bus but also in other transportation infrastructures, the unplanned delay time is likely to be accepted by the customer. On the other hand, the planned delay time is a delay specific to the demand bus, and occurs when a new customer is incorporated into the existing transportation plan. Therefore, the planned delay time is unlikely to be accepted by the customer. Since the planned delay time and the unplanned delay time are presented to the customer in a clearly separated manner, and an upper limit time is guaranteed for the planned delay time, a reasonable understanding of the occurrence of delay can be obtained from the customer.

The travel schedule transmitter 19 acquires the boarding delay upper limit time indicating the upper limit of the boarding delay time from the scheduled boarding date/time. The boarding delay upper limit time is stored in advance in the memory. The travel schedule transmitter 19 calculates a boarding delay allowable time obtained by subtracting the boarding delay time from the boarding delay upper limit time. The travel schedule transmitter 19 further outputs a boarding delay allowable time together with the boarding delay time. The travel schedule transmitter 19 transmits the boarding delay allowable time together with the boarding delay time to the customer terminal 2.

The travel schedule transmitter 19 acquires the disembark delay upper limit time indicating the upper limit of the disembark delay time from the scheduled disembark date/time. The disembark delay upper limit time is stored in advance in the memory. The travel schedule transmitter 19 calculates a disembark delay allowable time obtained by subtracting the disembark delay time from the disembark delay upper limit time. The travel schedule transmitter 19 further outputs a disembark delay allowable time together with the disembark delay time. The travel schedule transmitter 19 transmits the disembark delay allowable time together with the disembark delay time to the customer terminal 2.

By checking the boarding delay allowable time or the disembark delay allowable time, the existing customer can know how much the scheduled boarding date/time and the scheduled disembark date/time are likely to be further delayed.

The travel schedule transmitter 19 acquires a travel schedule request for requesting the travel schedule of one existing customer from the customer terminal 2 of the one existing customer. The customer terminal 2 periodically transmits the travel schedule request. The travel schedule request includes the customer ID. The travel schedule transmitter 19 receives the travel schedule request transmitted by the customer terminal 2 of the one existing customer. When acquiring the travel schedule request of the one existing customer, the travel schedule transmitter 19 outputs the boarding location of one existing customer, the scheduled boarding date/time of the one existing customer, the boarding delay time of the one existing customer, the disembark location of the one existing customer, the scheduled disembark date/time of the one existing customer, and the disembark delay time of the one existing customer in the new transportation plan in which the transportation request is incorporated into the existing transportation plan to the customer terminal 2 of the one existing customer.

The travel schedule transmitter 19 determines whether the one existing customer has already boarded at the current date/time. The travel schedule transmitter 19 acquires the scheduled boarding date/time of the one existing customer from the individual transportation plan of the vehicle boarded by the one existing customer. When the scheduled boarding date/time of one existing customer is not acquired from the individual transportation plan, the travel schedule transmitter 19 acquires the boarding date/time of the one existing customer from the bus stop departure log information stored in the vehicle dynamics log storage part 15. The travel schedule transmitter 19 compares the acquired scheduled boarding date/time or boarding date/time with the current date/time to determine whether the one existing customer has already boarded at the current date/time. When the acquired scheduled boarding date/time or boarding date/time is before the current date/time, the travel schedule transmitter 19 determines that the one existing customer has already boarded at the current date/time. When the acquired scheduled boarding date/time or boarding date/time is after the current date/time, the travel schedule transmitter 19 determines that the one existing customer has not boarded at the current date/time. In a case where it is determined that the one existing customer has already boarded at the current date/time, the travel schedule transmitter 19 further outputs information indicating that the one existing customer has already boarded to the customer terminal 2 of the one existing customer.

Next, the operation of the transportation plan creation server 1 in the first embodiment of the present disclosure will be described.

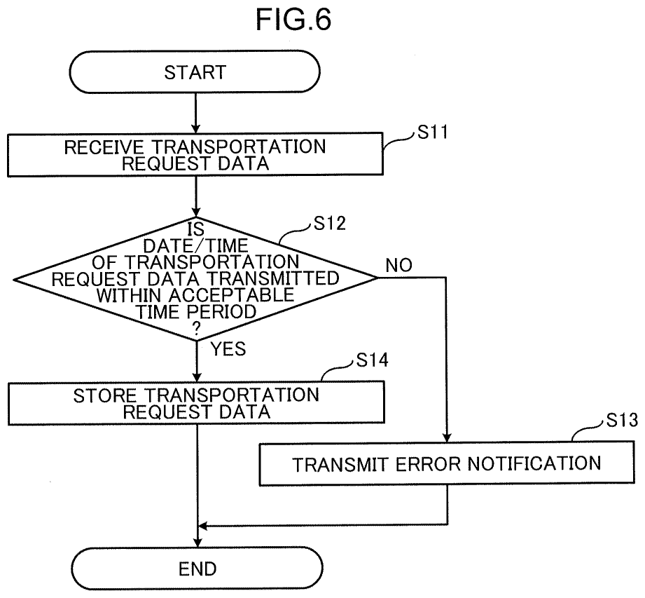

FIG. 6 is a flowchart for describing an operation of the transportation request receiver 16 of the transportation plan creation server 1 in an embodiment of the present disclosure. Note that the operation illustrated in FIG. 6 is performed with reception of the transportation request data as a trigger.

First, in step S11, the transportation request receiver 16 receives the transportation request data transmitted by the customer terminal 2.

Next, in step S12, the transportation request receiver 16 determines whether the date and time when the transportation request data is transmitted is within an acceptable time period. As an example of the definition of the acceptable time period, 12 hours or more before the desired boarding date/time included in the transportation request data can be considered. Therefore, the transportation request receiver 16 receives the transportation request data if the date and time when the transportation request data is transmitted is within the acceptable time period, and does not receive the transportation request data if the date and time when the transportation request data is transmitted is outside the acceptable time period.

Here, when it is determined that the desired boarding date/time is not within a predetermined time period (NO in step S12), in step S13, the transportation request receiver 16 transmits an error notification indicating that the transportation request data cannot be received to the customer terminal 2 that has transmitted the transportation request data.

On the other hand, when it is determined that the desired boarding date/time is within the predetermined time period (YES in step S12), the transportation request receiver 16 stores the received transportation request data in the first transportation request storage part 12 in step S14.

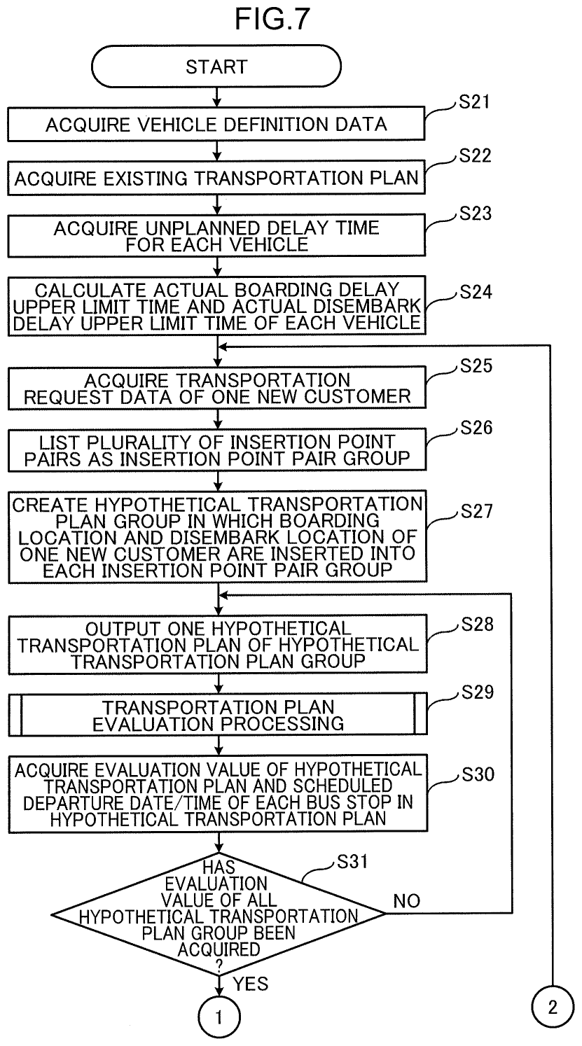

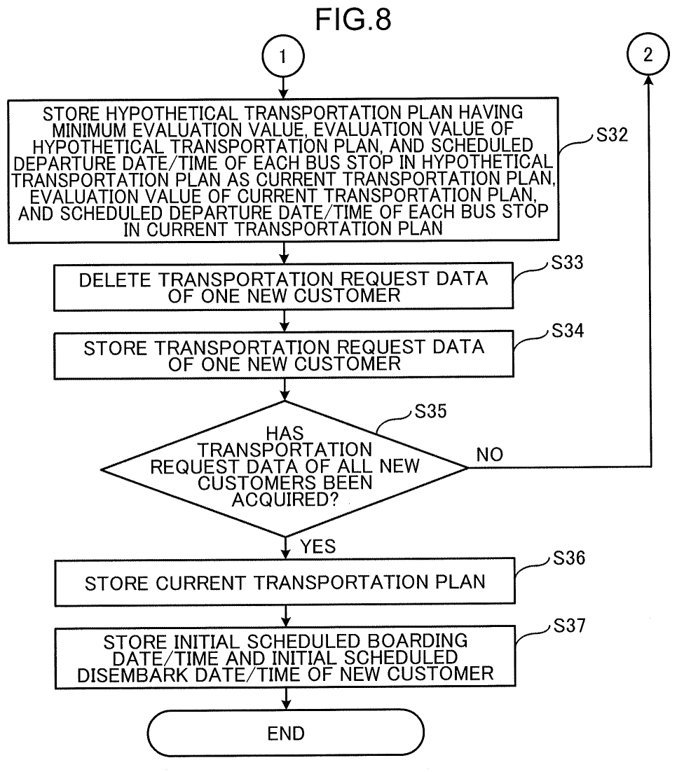

FIG. 7 is a first flowchart for describing the operation of the transportation plan creator 17 of the transportation plan creation server 1 in an embodiment of the present disclosure, and FIG. 8 is a second flowchart for describing the operation of the transportation plan creator 17 of the transportation plan creation server 1 in an embodiment of the present disclosure. Note that the operations illustrated in FIGS. 7 and 8 are performed at predetermined time intervals, for example, every two minutes or immediately after completion of processing.

First, in step S21, the transportation plan improver 171 acquires the vehicle definition data stored In the setting data storage part 11.

Next, in step S22, the transportation plan improver 171 acquires the existing transportation plan stored in the transportation plan storage part 14. The transportation plan improver 171 reads the existing transportation plan from the transportation plan storage part 14.

Next, in step S23, the transportation plan improver 171 acquires the unplanned delay time of each vehicle included in the acquired existing transportation plan from the vehicle delay time data stored in the vehicle dynamics log storage part 15.

Next, in step S24, the transportation plan improver 171 calculates the actual boarding delay upper limit time and the actual disembark delay upper limit time of each vehicle. The transportation plan improver 171 calculates the actual boarding delay upper limit time obtained by adding the unplanned delay time of each vehicle to the boarding delay upper limit time for each vehicle. The transportation plan improver 171 calculates the actual disembark delay upper limit time obtained by adding the unplanned delay time of each vehicle to the disembark delay upper limit time for each vehicle.

Next, in step S25, the transportation plan improver 171 acquires the transportation request data of one new customer from the first transportation request storage part 12.

Next, in step S26, the transportation plan improver 171 lists, as an insertion point pair group, a plurality of insertion point pairs for inserting the boarding location and the disembark location of one new customer into the existing transportation plan, the plurality of insertion point pairs satisfying the first to third constraint conditions.

Next, in step S27, the transportation plan improver 171 creates a hypothetical transportation plan group in which the boarding location and the disembark location of one new customer are inserted into each of the listed insertion point pair groups.

Then, in step S28, the transportation plan improver 171 outputs one hypothetical transportation plan of the hypothetical transportation plan group to the transportation plan evaluator 172.

Next, in step S29, the transportation plan evaluator 172 executes transportation plan evaluation processing of calculating the evaluation value of the hypothetical transportation plan created by the transportation plan improver 171 and the scheduled departure date/time of each bus stop in the hypothetical transportation plan. Note that the transportation plan evaluation processing will be described later.

Next, in step S30, the transportation plan improver 171 acquires the evaluation value of the hypothetical transportation plan and the scheduled departure date/time of each bus stop in the hypothetical transportation plan from the transportation plan evaluator 172.

Then, in step S31, the transportation plan improver 171 determines whether the evaluation value of all of the hypothetical transportation plan group has been acquired. Here, when it is determined that the evaluation value of all of the hypothetical transportation plan group has not been acquired (NO in step S31), the processing returns to step S28. Then, the transportation plan improver 171 outputs another one hypothetical transportation plan in which the evaluation value has not been acquired in the hypothetical transportation plan group to the transportation plan evaluator 172.

On the other hand, when it is determined that the evaluation value of all the hypothetical transportation plan group has been acquired (YES in step S31), in step S32, the transportation plan improver 171 stores the hypothetical transportation plan having the minimum evaluation value, the evaluation value of the hypothetical transportation plan, and the scheduled departure date/time of each bus stop in the hypothetical transportation plan in the memory as the current transportation plan, the evaluation value of the current transportation plan, and the scheduled departure date/time of each bus stop in the current transportation plan. When the current transportation plan, the evaluation value of the current transportation plan, and the scheduled departure date/time of each bus stop in the current transportation plan have already been stored in the memory, the transportation plan improver 171 overwrites the hypothetical transportation plan having the minimum evaluation value, the evaluation value of the hypothetical transportation plan, and the scheduled departure date/time of each bus stop in the hypothetical transportation plan.

Next, in step S33, the transportation plan improver 171 deletes the transportation request data of one new customer from the first transportation request storage part 12.

Then, in step S34, the transportation plan improver 171 stores the transportation request data of the one new customer deleted from the first transportation request storage part 12 in the second transportation request storage part 13.

Next, in step S35, the transportation plan improver 171 determines whether the transportation request data of all the new customers stored in the first transportation request storage part 12 has been acquired.

Here, when it is determined that the transportation request data of all the new customers has not been acquired (NO in step S35), the processing returns to step S25. Then, the transportation plan improver 171 acquires the transportation request data of another one new customer that has not been acquired yet from the first transportation request storage part 12.

On the other hand, when it is determined that the transportation request data of all the new customers has been acquired (YES in step S35), in step S36, the transportation plan improver 171 stores the current transportation plan in the transportation plan storage part 14.

Next, in step S37, the transportation plan improver 171 stores the scheduled boarding date/time and the scheduled disembark date/time of the new customer newly incorporated in the transportation plan in the transportation plan storage part 14 as the initial scheduled boarding date/time and the initial scheduled disembark date/time in association with the existing transportation plan.

Note that, by listing the insertion point pair group satisfying the third constraint condition, the insertion point pair in which the delay times of the scheduled boarding date/time and the scheduled disembark date/time of each existing customer included in the existing transportation plan exceed the boarding delay upper limit time and the disembark delay upper limit time is not listed. The hypothetical transportation plan having the minimum evaluation value is selected from the hypothetical transportation plan group.

As a result, when the boarding location and the disembark location of the new customer are inserted into the existing transportation plan, in a case where the delay times of the scheduled boarding date/time and the scheduled disembark date/time of each existing customer included in the existing transportation plan do not exceed the boarding delay upper limit time and the disembark delay upper limit time, the boarding location of the new customer is inserted at the first point before the disembark location of the last remaining existing customer in the individual transportation plan of the existing transportation plan, and the disembark location of the new customer is inserted at the first point or the second point after the disembark location of the last remaining existing customer in the individual transportation plan of the existing transportation plan. That is, in this case, the above-described detour insertion method is applied.

On the other hand, when the boarding location and the disembark location of the new customer are inserted into the existing transportation plan, in case where the delay times of the scheduled boarding date/time and the scheduled disembark date/time of each existing customer included in the existing transportation plan exceed the boarding delay upper limit time and the disembark delay upper limit time, the boarding location and the disembark location of the new customer are inserted at the second point. That is, in this case, the above-described last insertion method is applied.

Since the actual boarding delay upper limit time obtained by adding the unplanned delay time to the boarding delay upper limit time and the actual disembark delay upper limit time obtained by adding the unplanned delay time to the disembark delay upper limit time are used, even if the unplanned delay time due to a change in the traffic situation occurs, the upper limit time does not affect the boarding delay allowable time and the disembark delay allowable time, and affects only the planned delay time caused by inserting the boarding location and the disembark location of the new customer into the existing transportation plan.

As described above, when the boarding location of the new customer is inserted at the first point that is before the disembark location of the last remaining existing customer in the existing transportation plan, in a case where the delay time of each of the plurality of existing customers does not exceed the predetermined upper limit time, the boarding location of the new customer is inserted at the first point, and it is thus possible to suppress the delay from the scheduled boarding date/time and the scheduled disembark date/time of the existing customer allocated to the existing transportation plan.

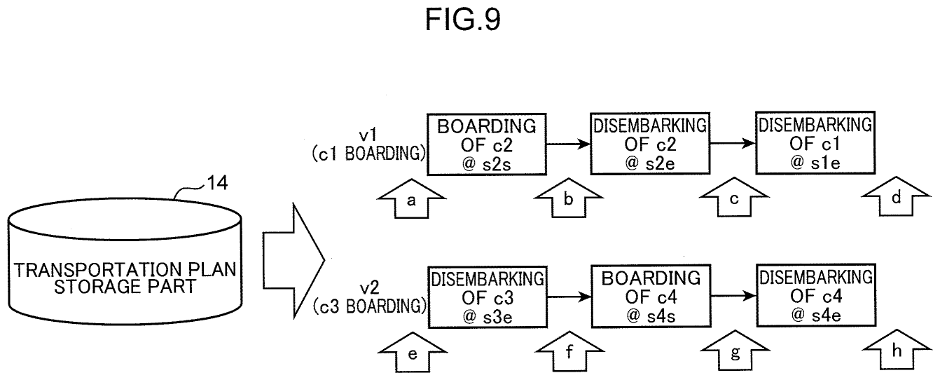

FIG. 9 is a schematic diagram for describing processing of listing the insertion point pair group by the transportation plan improver 171 in the present embodiment.

The transportation plan improver 171 lists, as the insertion point pair group, the plurality of insertion point pairs for inserting the boarding location and the disembark location of one new customer in the existing transportation plan acquired from the transportation plan storage part 14.

In FIG. 9, a customer c1 is already on board in the vehicle v1. In the individual transportation plan of the vehicle v1, a bus stop s2s which is a boarding location of a customer c2, a bus stop s2e which is a disembark location of the customer c2, and a bus stop s1e which is a disembark location of the customer c1 are visited in that order. A customer c3 is already on board in the vehicle v2. In the individual transportation plan of the vehicle v2, a bus stop s3e which is a disembark location of the customer c3, a bus stop s4s which is a boarding location of a customer c4, and a bus stop s4e which is a disembark location of the customer c4 are visited in order.

Insertion points a to h illustrated in FIG. 9 are candidates of points at which a boarding location and a disembark location of one new customer can be inserted. Combinations of the insertion point pairs of a boarding location and a disembark location of one new customer are (a, a), (a, b), (a, c), (a, d), (b, b), (b, c), (b, d), (c, c), (c, d), (d, d), (e, e), (e, f), (e, g), (e, h), (f, f), (f, g), (f, h), (g, g), (g, h), and (h, h). The transportation plan improver 171 lists an insertion point pair group satisfying the first to third constraint conditions from these insertion point pairs. Note that a combination of (d, d) and (h, h) in the above insertion point pairs represents insertion by the last insertion method, and the other combinations represent insertion by the detour insertion method.

Next, details of the transportation plan evaluation processing in step S29 of FIG. 7 will be described.

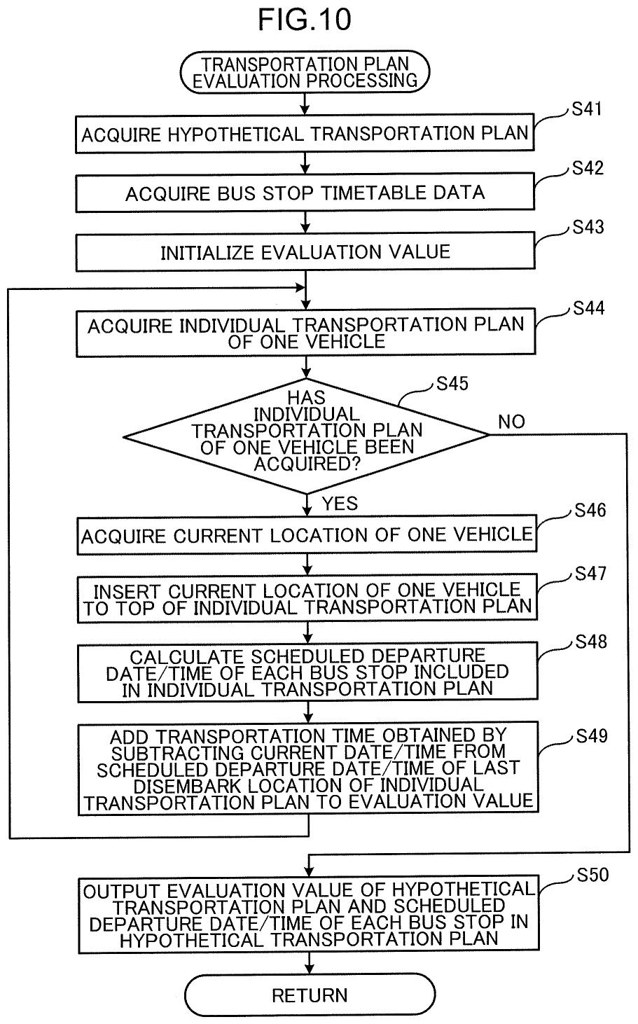

FIG. 10 is a flowchart for describing the transportation plan evaluation processing of the transportation plan creation server 1 in the present embodiment.

First, in step S41, the transportation plan evaluator 172 acquires the hypothetical transportation plan created by the transportation plan improver 171.

Next, in step S42, the transportation plan evaluator 172 acquires the bus stop timetable data from the setting data storage part 11.

Next, in step S43, the transportation plan evaluator 172 initializes the evaluation value. That is, the transportation plan evaluator 172 sets the evaluation value to 0.

Next, in step S44, the transportation plan evaluator 172 acquires the individual transportation plan of one vehicle from the hypothetical transportation plan.

Next, in step S45, the transportation plan evaluator 172 determines whether the individual transportation plan of one vehicle has been acquired from the hypothetical transportation plan.

Here, when it is determined that the individual transportation plan of one vehicle has been acquired (YES in step S45), in step S46, the transportation plan evaluator 172 acquires the current location of the one vehicle from the vehicle state log information stored in the vehicle dynamics log storage part 15.

Next, in step S47, the transportation plan evaluator 172 inserts the acquired current location of the one vehicle to the top of the individual transportation plan.

Then, in step S48, the transportation plan evaluator 172 calculates the scheduled departure date/time of each bus stop included in the individual transportation plan. At this time, the transportation plan evaluator 172 determines a scheduled arrival date/time of each bus stop by adding the movement time between bus stops included in the bus stop timetable data acquired from the setting data storage part 11 on the basis of the departure date/time of the bus stop from which the vehicle has last departed. When the scheduled arrival date/time at the bus stop is earlier than the desired boarding date/time included in the transportation request data of the customer boarding at the bus stop, the transportation plan evaluator 172 replaces the scheduled arrival date/time with the desired boarding date/time. The transportation plan evaluator 172 calculates the scheduled departure date/time of the bus stop by adding a predetermined time required for the customer to board and disembark at the bus stop to the determined scheduled arrival date/time of the bus stop.

Next, in step S49, the transportation plan evaluator 172 adds, to the evaluation value, the transportation time obtained by subtracting the current date/time from the scheduled departure date/time of the last disembark location (bus stop) in the individual transportation plan. The processing then returns to step S44. Then, the processing of steps S44 to S49 is performed until the individual transportation plans of all the vehicles are acquired from the hypothetical transportation plan.

On the other hand, when it is determined that the individual transportation plan of one vehicle is not acquired from the hypothetical transportation plan, that is, when it is determined that the individual transportation plans of all the vehicles are acquired from the hypothetical transportation plan (NO in step S45), in step S50, the transportation plan evaluator 172 outputs the calculated evaluation value of the hypothetical transportation plan and the scheduled departure date/time of each bus stop in the hypothetical transportation plan to the transportation plan improver 171.

In the present embodiment, the transportation plan evaluator 172 calculates the transportation time of one vehicle, but the present disclosure is not limited to this calculation, and the transportation plan evaluator 172 may calculate the transportation distance of the one vehicle. In this case, the transportation plan evaluator 172 may calculate the transportation distance from the disembark location of the customer who last disembarks from one vehicle to the current location of the one vehicle by using the inter-bus stop distance table data.

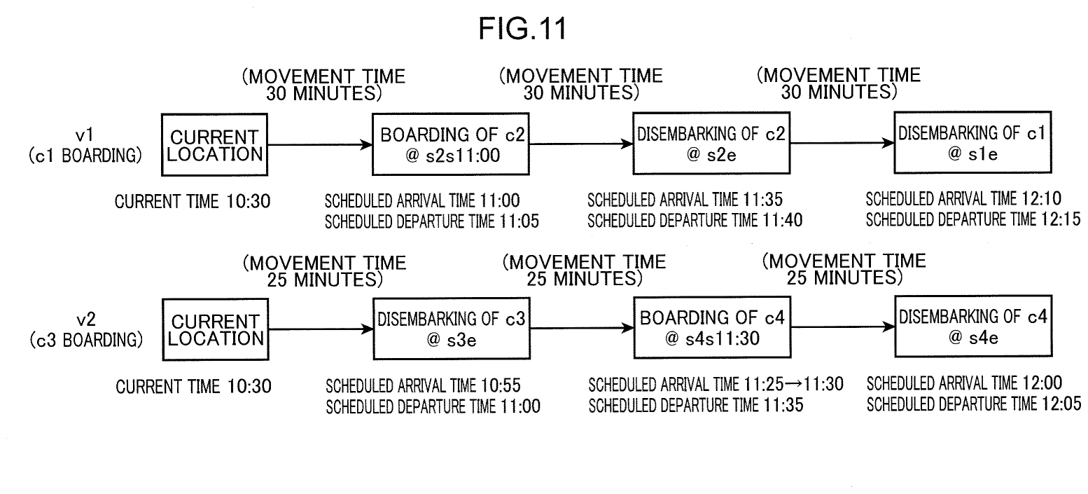

FIG. 11 is a schematic diagram for describing processing of calculating the scheduled departure date/time by the transportation plan evaluator 172 in the present embodiment. In order to simplify the description, FIG. 11 shows a current time, a desired boarding time, a scheduled arrival time, and a scheduled departure time instead of the current date/time, the desired boarding date/time, the scheduled arrival date/time, and the scheduled departure date/time.

In FIG. 11, the customer c1 is already on board in the vehicle v1. In the individual transportation plan of the vehicle v1, a bus stop s2s which is a boarding location of a customer c2, a bus stop s2e which is a disembark location of the customer c2, and a bus stop s1e which is a disembark location of the customer c1 are visited in that order. The desired boarding time of the customer c2 is 11:00. A customer c3 is already on board in the vehicle v2. In the individual transportation plan of the vehicle v2, a bus stop s3e which is a disembark location of the customer c3, a bus stop s4s which is a boarding location of a customer c4, and a bus stop s4e which is a disembark location of the customer c4 are visited in order. The desired boarding time of the customer c4 is 11:30.

The current time is 10:30. The time required for the customer to board and disembark at the bus stop is set to five minutes.

The current location of the vehicle v1 is inserted at the top of the individual transportation plan of the vehicle v1, and the current location of the vehicle v2 is inserted at the top of the individual transportation plan of the vehicle v2.

First, the transportation plan evaluator 172 acquires a bus stop from which the vehicle has last departed and the departure date/time of the bus stop from the bus stop departure log information stored in the vehicle dynamics log storage part 15. Next, the transportation plan evaluator 172 acquires the movement time from the bus stop from which the vehicle has last departed to the bus stop at which the vehicle stops next from the bus stop timetable data stored in the setting data storage part 11. Next, the transportation plan evaluator 172 adds the acquired movement time to the departure date/time of the bus stop from which the vehicle has last departed to calculate the scheduled arrival date/time of the bus stop at which the vehicle stops next. Next, the transportation plan evaluator 172 calculates the scheduled departure date/time of the bus stop at which the vehicle stops next by adding the time required for the customer to board and disembark to the scheduled arrival date/time of the bus stop at which the vehicle stops next. Thereafter, the transportation plan evaluator 172 calculates the scheduled arrival date/time of the bus stop at which the vehicle stops next by adding the movement time between the bus stop at which the vehicle stops one time before and the bus stop at which the vehicle stops next to the scheduled departure date/time of the bus stop at which the vehicle has stopped one time before. The transportation plan evaluator 172 calculates the scheduled departure date/time of the bus stop at which the vehicle stops next by adding the time required for the customer to board and disembark to the scheduled arrival date/time of the bus stop at which the vehicle stops next.

The scheduled arrival time at the bus stop s2s of the vehicle v1 is 11:00, and the scheduled departure time from the bus stop s2s of the vehicle v1 is 11:05. Since the movement time between the bus stop s2s and the bus stop s2e is 30 minutes, the scheduled arrival time at the bus stop s2e of the vehicle v1 is 11:35, and the scheduled departure time from the bus stop s2e of the vehicle v1 is 11:40. Since the movement time between the bus stop s2e and the bus stop s1e is 30 minutes, the scheduled arrival time at the bus stop s1e of the vehicle v1 is 12:10, and the scheduled departure time from the bus stop s1e of the vehicle v1 is 12:15.

The scheduled arrival time at the bus stop s3e of the vehicle v2 is 10:55, and the scheduled departure time from the bus stop s3e of the vehicle v2 is 11:00. Since the movement time between the bus stop s3e and the bus stop s4s is 25 minutes, the scheduled arrival time at the bus stop s4s of the vehicle v2 is 11:25. Here, the desired boarding time of the customer c4 is 11:30, and the vehicle v2 arrives at the bus stop s4s earlier than the desired boarding time. In this case, the transportation plan evaluator 172 replaces the scheduled arrival time with the desired boarding time. Therefore, the scheduled arrival time at the bus stop s4s of the vehicle v2 is replaced with 11:30, and the scheduled departure time from the bus stop s4s of the vehicle v2 is 11:35. Since the movement time between the bus stop s4s and the bus stop s4e is 25 minutes, the scheduled arrival time of the bus stop s4e of the vehicle v2 is 12:00, and the scheduled departure time of the bus stop s4e of the vehicle v2 is 12:05.

Next, the operation of the vehicle dynamics monitor 18 of the transportation plan creation server 1 in an embodiment of the present disclosure will be described.

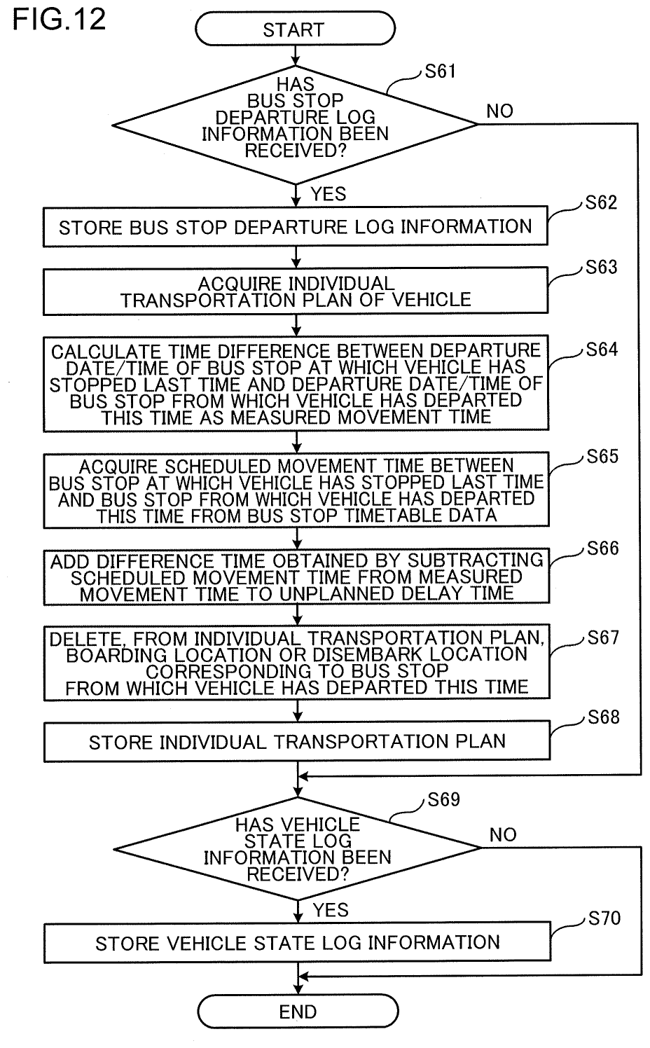

FIG. 12 is a flowchart for describing the operation of the vehicle dynamics monitor 18 of the transportation plan creation server 1 in an embodiment of the present disclosure.

First, in step S61, the vehicle dynamics monitor 18 determines whether the bus stop departure log information has been received.

The vehicle terminal 3 displays a button for transmitting the bus stop departure log information on a touch panel at a timing when the vehicle departs from a bus stop, and receives pressing (touching) of the button by the driver. When the button is pressed (touched) by the driver, the vehicle dynamics monitor 18 creates the bus stop departure log information and transmits the created bus stop departure log information to the transportation plan creation server 1. The bus stop departure log information includes a vehicle ID, a bus stop ID, a customer ID of a customer who boards and disembarks at the bus stop, and a departure date/time of the bus stop. The vehicle ID is stored in the vehicle terminal 3 in advance. The bus stop ID of the bus stop from which the vehicle departs can be acquired by referring to the individual transportation plan stored in the vehicle terminal 3. The customer ID of the customer who boards and departs at the bus stop can be acquired by referring to the individual transportation plan stored in the vehicle terminal 3. The departure date/time of the bus stop is the date and time when the button is pressed or the date and time when the bus stop departure log information is transmitted.

Note that the bus stop ID of the bus stop from which the vehicle departs may be specified from the current location of the vehicle terminal 3 (vehicle). That is, the vehicle terminal 3 may store in advance a table in which the bus stop ID and the location of the bus stop are associated with each other. The vehicle terminal 3 may acquire the current location of the vehicle terminal 3 (vehicle) and acquire the bus stop ID associated with the current location.

The customer ID of the customer who boards and disembarks at the bus stop may be acquired by detecting boarding and disembarking of the customer. For example, the vehicle may include a reader that reads a two-dimensional code. When the customer boards the vehicle, the reader may acquire the customer ID of the customer who boards the vehicle by reading the two-dimensional code displayed on the customer terminal 2 of the customer who boards the vehicle, and transmit the acquired customer ID to the vehicle terminal 3. When the customer disembarks the vehicle, the reader may acquire the customer ID of the customer who disembarks the vehicle by reading the two-dimensional code displayed on the customer terminal 2 of the customer who disembarks the vehicle, and transmit the acquired customer ID to the vehicle terminal 3. As a result, the vehicle terminal 3 can acquire the customer ID of the customer who boards and disembarks at the bus stop.

Here, when it is determined that the bus stop departure log information has not been received (NO in step S61), the processing proceeds to step S69.

On the other hand, when it is determined that the bus stop departure log information has been received (YES in step S61), the vehicle dynamics monitor 18 stores the received bus stop departure log information in the vehicle dynamics log storage part 15 in step S62.

Next, in step S63, the vehicle dynamics monitor 18 acquires the individual transportation plan of the vehicle corresponding to the vehicle ID included in the bus stop departure log information from the transportation plan storage part 14.

Next, in step S64, the vehicle dynamics monitor 18 calculates a time difference between the departure date/time of the bus stop at which the vehicle has stopped last time and the departure date/time of the bus stop from which the vehicle has departed this time as the measured movement time.

Then, in step S65, the vehicle dynamics monitor 18 acquires the scheduled movement time between the bus stop at which the vehicle has stopped last time and the bus stop from which the vehicle has departed this time from the bus stop timetable data.

Next, in step S66, the vehicle dynamics monitor 18 adds a difference time obtained by subtracting the scheduled movement time from the measured movement time to the unplanned delay time of the vehicle corresponding to the vehicle ID included in the bus stop departure log information in vehicle delay time data stored in the vehicle dynamics log storage part 15. Note that the difference time obtained by subtracting the scheduled movement time from the measured movement time may be negative. If the difference time is negative, the unplanned delay time will decrease.

Next, in step S67, the vehicle dynamics monitor 18 deletes, from the acquired individual transportation plan, the boarding location or the disembark location corresponding to the bus stop from which the vehicle has departed this time.

Then, in step S68, the vehicle dynamics monitor 18 stores the individual transportation plan in which the boarding location or the disembark location corresponding to the bus stop from which the vehicle has departed this time is deleted in the transportation plan storage part 14.

Next, in step S69, the vehicle dynamics monitor 18 determines whether the vehicle state log information has been received.

The vehicle terminal 3 periodically creates the vehicle state log information and transmits the created vehicle state log information to the transportation plan creation server 1. The vehicle state log information includes a vehicle ID, a current location of the vehicle, the number of customers who are currently on board in the vehicle, and current date/time. The vehicle ID is stored in the vehicle terminal 3 in advance. The current location of the vehicle can be acquired from a global positioning system (GPS) receiver included in the vehicle terminal 3. The number of customers who are currently on board in the vehicle can be acquired by referring to the individual transportation plan stored in the vehicle terminal 3. The current date/time is the date and time when the vehicle state log information is transmitted.

Note that the number of customers who are currently on board in the vehicle may be calculated by detecting boarding and disembarking of the customers. For example, the vehicle may include a reader that reads a two-dimensional code. When the customer boards the vehicle, the reader may acquire the customer ID of the customer who boards the vehicle by reading the two-dimensional code displayed on the customer terminal 2 of the customer who boards the vehicle, and transmit the acquired customer ID to the vehicle terminal 3. When the customer disembarks the vehicle, the reader may acquire the customer ID of the customer who disembarks the vehicle by reading the two-dimensional code displayed on the customer terminal 2 of the customer who disembarks the vehicle, and transmit the acquired customer ID to the vehicle terminal 3. As a result, the vehicle terminal 3 can acquire the customer ID of the customer who boards the vehicle and the customer ID of the customer who disembarks the vehicle, and calculate the number of customers who are currently on board in the vehicle.

Here, when it is determined that the vehicle state log information has not been received (NO in step S69), the processing ends.

On the other hand, when it is determined that the vehicle state log information has been received (YES in step S69), the vehicle dynamics monitor 18 stores the received vehicle state log information in the vehicle dynamics log storage part 15 in step S70.

In the present embodiment, the vehicle terminal 3 transmits the bus stop departure log information to the transportation plan creation server 1 when the vehicle departs from the bus stop, but the present disclosure is not limited thereto. The vehicle terminal 3 may transmit bus stop arrival log information to the transportation plan creation server 1 when the vehicle arrives at the bus stop. In this case, the bus stop arrival log information may include a vehicle ID, a bus stop ID, a customer ID of a customer who boards and disembarks at the bus stop, and an arrival date/time of the bus stop. The vehicle dynamics monitor 18 may receive bus stop arrival log information from the vehicle terminal 3. The vehicle dynamics monitor 18 may store the received bus stop arrival log information in the vehicle dynamics log storage part 15. The vehicle dynamics monitor 18 may calculate the measured movement time on the basis of the received bus stop arrival log information.

Next, an operation in which the travel schedule transmitter 19 of the transportation plan creation server 1 transmits the travel schedule of the customer in an embodiment of the present disclosure will be described.

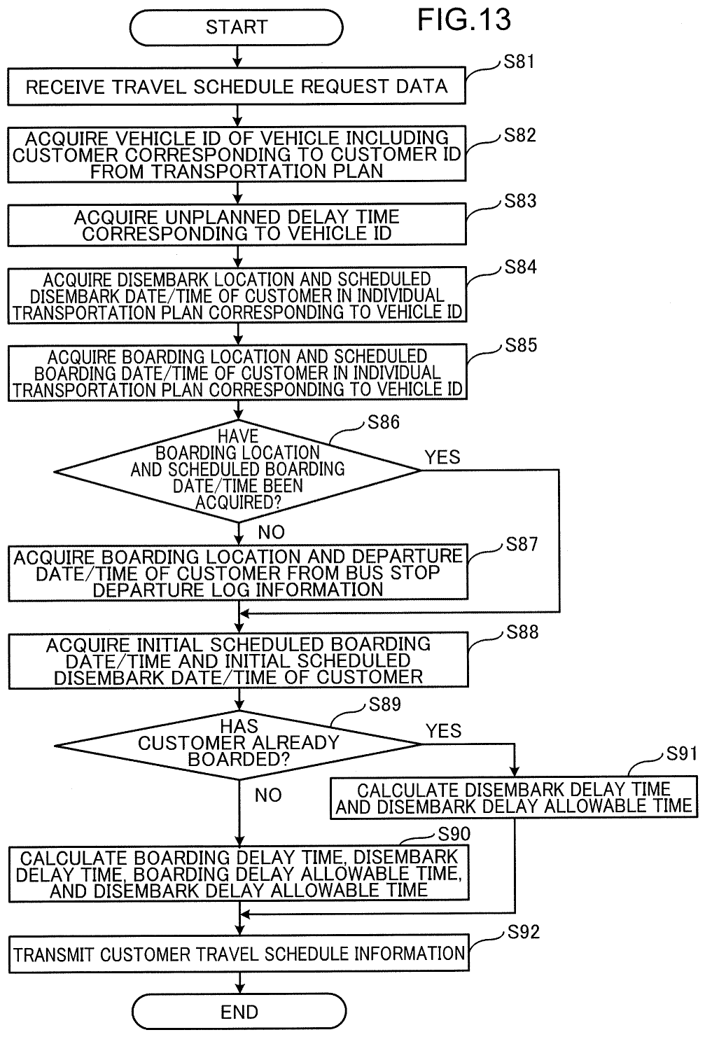

FIG. 13 is a flowchart for describing a customer travel schedule transmission operation of the travel schedule transmitter 19 of the transportation plan creation server 1 in an embodiment of the present disclosure.

First, in step S81, the travel schedule transmitter 19 receives travel schedule request data for requesting the travel schedule of the customer from the customer terminal 2. The travel schedule request data includes the customer ID. The customer ID is stored in the customer terminal 2 in advance. The customer terminal 2 of a customer on board or a customer who has made a reservation periodically transmits the travel schedule request data to the transportation plan creation server 1 as a query. The travel schedule transmitter 19 starts the processing with reception of the travel schedule request data as a trigger.

Next, in step S82, the travel schedule transmitter 19 acquires the vehicle ID of the vehicle including the customer corresponding to the customer ID included in the received travel schedule request data from the transportation plan stored in the transportation plan storage part 14.

Next, in step S83, the travel schedule transmitter 19 acquires the unplanned delay time corresponding to the acquired vehicle ID from the vehicle delay time data stored in the vehicle dynamics log storage part 15.

Next, in step S84, the travel schedule transmitter 19 acquires the disembark location and the scheduled disembark date/time of the customer in the individual transportation plan corresponding to the acquired vehicle ID from the transportation plan stored in the transportation plan storage part 14.

Then, in step S85, the travel schedule transmitter 19 acquires the boarding location and the scheduled boarding date/time of the customer in the individual transportation plan corresponding to the acquired vehicle ID from the transportation plan stored in the transportation plan storage part 14.

Next, in step S86, the travel schedule transmitter 19 determines whether the boarding location and the scheduled boarding date/time of the customer in the individual transportation plan corresponding to the acquired vehicle ID have been acquired from the transportation plan stored in the transportation plan storage part 14. When the customer has already boarded the vehicle, the boarding location of the customer is deleted from the transportation plan stored in the transportation plan storage part 14, and thus, the boarding location and the scheduled boarding date/time of the customer are not acquired from the transportation plan.

Here, when it is determined that the boarding location of the customer and the scheduled boarding date/time have been acquired (YES in step S86), the processing shifts to step S88.

On the other hand, when it is determined that the boarding location and the scheduled boarding date/time of the customer have not been acquired (NO in step S86), in step S87, the travel schedule transmitter 19 acquires the boarding location and the boarding date/time (departure date/time) of the customer from the bus stop departure log information stored in the vehicle dynamics log storage part 15. When the customer has already boarded the vehicle, the travel schedule transmitter 19 acquires the departure date/time of the customer as the boarding date/time from the bus stop departure log information.

Next, in step S88, the travel schedule transmitter 19 acquires the initial scheduled boarding date/time and the initial scheduled disembark date/time of the customer associated with the transportation plan stored in the transportation plan storage part 14.

Then, in step S89, the travel schedule transmitter 19 determines whether the customer has already boarded. Here, when the acquired scheduled boarding date/time or boarding date/time is before the current date/time, the travel schedule transmitter 19 determines that the customer has already boarded. When the acquired scheduled boarding date/time or boarding date/time is after the current date/time, the travel schedule transmitter 19 determines that the customer has not boarded.

Here, when it is determined that the customer has not boarded (NO in step S89), the travel schedule transmitter 19 calculates the boarding delay time, the disembark delay time, the boarding delay allowable time, and the disembark delay allowable time in step S90. The travel schedule transmitter 19 calculates the boarding delay time, the disembark delay time, the boarding delay allowable time, and the disembark delay allowable time on the basis of the following equations (1) to (4).

Boarding delay time=max(0,scheduled boarding date/time−initial scheduled boarding date/time−unplanned delay time) (1)

Disembark delay time=max(0,scheduled disembark date/time−initial scheduled disembark date/time−unplanned delay time) (2)

Boarding delay allowable time=boarding delay upper limit time−boarding delay time (3)

Disembark delay allowable time=disembark delay upper limit time−disembark delay time (4)

In the above equations (1) and (2), max(0, X) means adopting the larger value of 0 or X. When the value of “scheduled boarding date/time−initial scheduled boarding date/time−unplanned delay time” or the value of “scheduled disembark date/time−initial scheduled disembark date/time−unplanned delay time” is negative, the boarding delay time or the disembark delay time is 0.

The boarding delay upper limit time and the disembark delay upper limit time are stored in advance in the memory. The travel schedule transmitter 19 acquires the boarding delay upper limit time and the disembark delay upper limit time from the memory.

On the other hand, when it is determined that the customer has already boarded (YES in step S89), the travel schedule transmitter 19 calculates the disembark delay time and the disembark delay allowable time in step S91. The travel schedule transmitter 19 calculates the disembark delay time and the disembark delay allowable time on the basis of the above equations (2) and (4).

Next, in step S92, the travel schedule transmitter 19 transmits the customer travel schedule information indicating the travel schedule of the customer to the customer terminal 2. When the customer has not boarded the vehicle, the travel schedule transmitter 19 creates the customer travel schedule information including the vehicle ID of the vehicle that the customer boards, the boarding location of the customer, the scheduled boarding date/time of the customer, the information indicating whether the customer has boarded, the boarding delay time of the customer, the boarding delay allowable time of the customer, the disembark location of the customer, the scheduled disembark date/time of the customer, the disembark delay time of the customer, the disembark delay allowable time of the customer, and the unplanned delay time. When the customer has already boarded the vehicle, the travel schedule transmitter 19 creates the customer travel schedule information including the vehicle ID of the vehicle that the customer boards, the boarding location of the customer, the boarding date/time of the customer, the information indicating whether the customer has boarded, the disembark location of the customer, the scheduled disembark date/time of the customer, the disembark delay time of the customer, the disembark delay allowable time of the customer, and the unplanned delay time.

When the boarding location and the disembark location of the new customer are inserted into the existing transportation plan in this manner, at least one of the boarding delay time or the disembark delay time indicating the time delayed from at least one of the scheduled boarding date/time or the scheduled disembark date/time of the one existing customer in the existing transportation plan is calculated, and the calculated at least one of the boarding delay time or the disembark delay time is output.

Therefore, since at least one of the boarding delay time or the disembark delay time indicating the time delayed from at least one of the scheduled boarding date/time or the scheduled disembark date/time of the one existing customer in the existing transportation plan is presented to the one existing customer, the delay time caused by incorporating the transportation request of the new customer into the existing transportation plan can be presented to the existing customer allocated to the existing transportation plan. As a result, a reasonable understanding of the delay time thus caused can be obtained from the existing customer allocated to the existing transportation plan.

Subsequently, various screens displayed on the customer terminal 2 will be described.

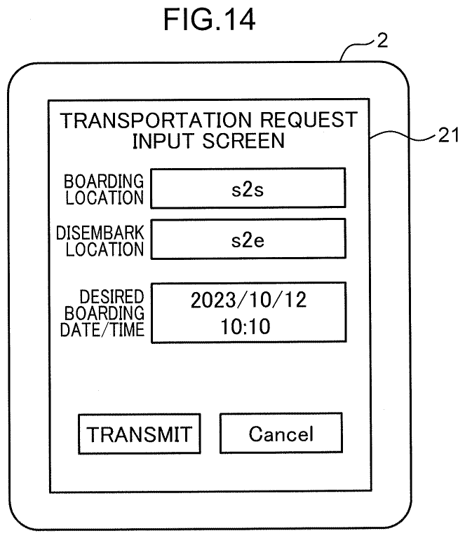

FIG. 14 is a diagram illustrating an example of a transportation request input screen displayed on the customer terminal 2 in the present embodiment.

Each of the plurality of customer terminals 2 includes a display part 21 configured by a liquid crystal display device or a touch panel. As illustrated in FIG. 14, the display part 21 displays the transportation request input screen for receiving input of the boarding location, the disembark location, and the desired boarding date/time by a customer. The customer inputs the boarding location, the disembark location, and the desired boarding date/time on the displayed transportation request input screen. In the present embodiment, since the operation route and the stop place of the vehicle are determined in advance, the customer selects the boarding location and the disembark location from among a plurality of predetermined stop places.

The transportation request input screen includes a transmission button and a cancel button. When the transmission button is clicked or touched, the transportation request data including the customer ID, the boarding location, the disembark location, and the desired boarding date/time is transmitted to the transportation plan creation server 1. When the cancel button is clicked or touched, the input boarding location, disembark location, and desired boarding date/time are canceled.

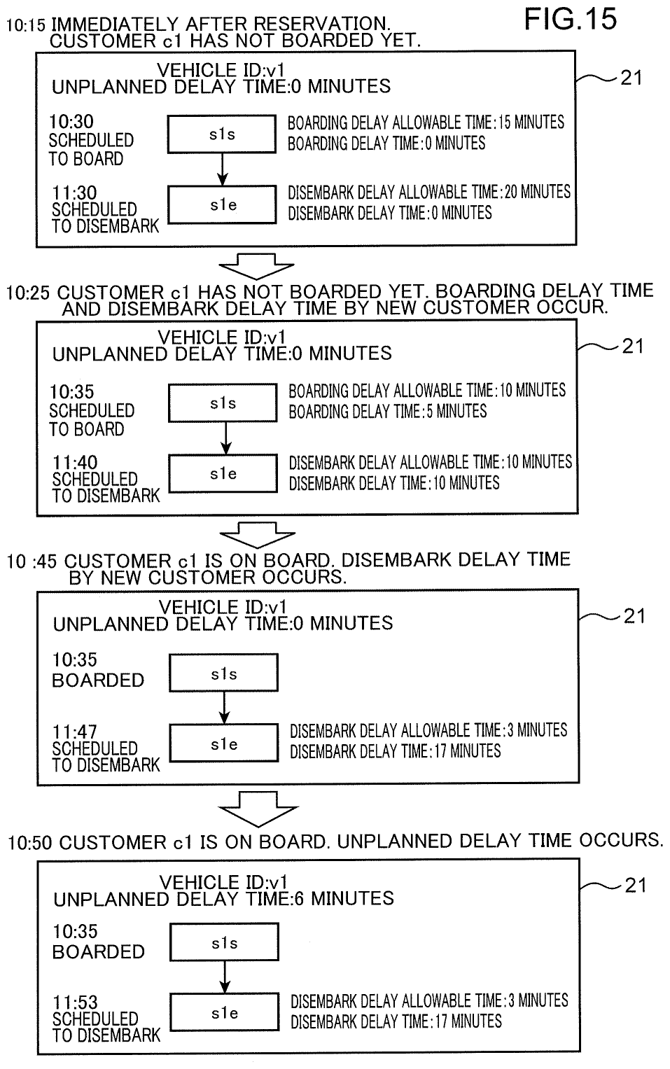

FIG. 15 is a diagram illustrating an example of a travel schedule notification screen displayed on the customer terminal 2 in the present embodiment. FIG. 15 illustrates the travel schedule notification screen that changes with the lapse of time.

The customer terminal 2 receives the customer travel schedule information transmitted by the transportation plan creation server 1. When the customer travel schedule information is received, the display part 21 of the customer terminal 2 displays the travel schedule notification screen for notifying the travel schedule of the customer on the basis of the received customer travel schedule information.

When the customer has not boarded the vehicle, the customer travel schedule information includes the vehicle ID of the vehicle that the customer boards, the boarding location of the customer, the scheduled boarding date/time of the customer, the information indicating whether the customer has boarded, the boarding delay time of the customer, the boarding delay allowable time of the customer, the disembark location of the customer, the scheduled disembark date/time of the customer, the disembark delay time of the customer, the disembark delay allowable time of the customer, and the unplanned delay time. When the customer has already boarded the vehicle, the customer travel schedule information includes the vehicle ID of the vehicle that the customer boards, the boarding location of the customer, the boarding date/time of the customer, the information indicating whether the customer has boarded, the disembark location of the customer, the scheduled disembark date/time of the customer, the disembark delay time of the customer, the disembark delay allowable time of the customer, and the unplanned delay time.

For example, when the customer c1 has not boarded yet at 10:15 on Oct. 12, 2023 immediately after reservation, the travel schedule notification screen displayed on the display part 21 includes the vehicle ID of the vehicle that the customer c1 boards, the unplanned delay time, the scheduled boarding date/time, the boarding location, the boarding delay time, the boarding delay allowable time, the scheduled disembark date/time, the disembark location, the disembark delay time, and the disembark delay allowable time. For example, the boarding delay time is 0 minute, the boarding delay allowable time is 15 minutes, the disembark delay time is 0 minute, and the disembark delay allowable time is 20 minutes.

Then, at 10:25 on Oct. 12, 2023, when the customer c1 has not boarded yet and the boarding delay time and the disembark delay time by the new customer occur, the display part 21 displays the travel schedule notification screen including the vehicle ID of the vehicle that the customer c1 boards, the unplanned delay time, the scheduled boarding date/time, the boarding location, the boarding delay time, the boarding delay allowable time, the scheduled disembark date/time, the disembark location, the disembark delay time, and the disembark delay allowable time. At this time, the scheduled boarding date/time is increased by five minutes from immediately after reservation, the boarding delay time is five minutes, and the boarding delay allowable time is decreased by five minutes from immediately after the reservation. The scheduled disembark date/time is increased by 10 minutes from immediately after reservation, the disembark delay time is 10 minutes, and the disembark delay allowable time is decreased by 10 minutes from immediately after reservation.

Then, at 10:45 on Oct. 12, 2023, when the customer c1 is on board and the disembark delay time by the new customer occurs, the display part 21 displays the travel schedule notification screen including the vehicle ID of the vehicle that the customer c1 boards, the unplanned delay time, the boarding date/time, the boarding location, the scheduled disembark date/time, the disembark location, the disembark delay time, and the disembark delay allowable time. At this time, the scheduled disembark date/time is increased by 7 minutes from a previous change of the transportation plan, the disembark delay time is 17 minutes, and the disembark delay allowable time is decreased by 7 minutes from the previous change of the transportation plan. Since customer c1 is already on board, the boarding delay time and the boarding delay allowable time are not displayed. The displayed boarding date/time is the date and time when the vehicle actually departs from the boarding location.

Then, at 10:50 on Oct. 12, 2023, when the customer c1 is on board and the unplanned delay time occurs, the display part 21 displays the travel schedule notification screen including the vehicle ID of the vehicle that the customer c1 boards, the unplanned delay time, the boarding date/time, the boarding location, the scheduled disembark date/time, the disembark location, the disembark delay time, and the disembark delay allowable time. At this time, the unplanned delay time is increased by six minutes from the previous change of the transportation plan.

The travel schedule notification screen is displayed when the customer has not disembarked the vehicle. The travel schedule notification screen illustrated in FIG. 15 displays only the travel schedule related to boarding and disembarking of the customer in consideration of privacy of the customer. The displayed boarding location and disembark location may be an ID for identifying a bus stop or a name of the bus stop. Whether the customer is scheduled to board or has boarded is displayed on the basis of the information indicating whether the customer included in the customer travel schedule information has boarded.

Next, an operation of the travel schedule transmitter 19 of the transportation plan creation server 1 in a first modification of the embodiment of the present disclosure will be described. In the above embodiment, only the travel schedule of the customer who has transmitted the travel schedule request data is displayed, but in the first modification of the embodiment, not only the travel schedule of the customer who has transmitted the travel schedule request data but also the travel schedule of another customer who boards the same vehicle are displayed.

The travel schedule transmitter 19 in the first modification of the present embodiment outputs the boarding locations of all the existing customers and the new customers in the vehicle that one existing customer boards, the scheduled boarding date/time of all the existing customers and the new customers, the boarding delay time of all the existing customers and the new customers, the disembark locations of all the existing customers and the new customers, the scheduled disembark date/time of all the existing customers and the new customers, and the disembark delay time of all the existing customers and the new customers in the new transportation plan in which the transportation request is incorporated into the existing transportation plan to the customer terminal 2 of the one existing customer.

The travel schedule transmitter 19 calculates a time difference between the departure date/time of the vehicle at the plurality of stop places, which are places where other existing customers who board the same vehicle as the one existing customer board and disembark in the past, and the departure date/time of the vehicle at the stop place one stop before the plurality of stop places as the measured movement time. The travel schedule transmitter 19 acquires a scheduled movement time between a plurality of preset stop places and a stop place one stop before the plurality of stop places. The travel schedule transmitter 19 calculates a movement delay time which is a difference between the measured movement time and the scheduled movement time between the stop places among the plurality of stop places. In the output of at least one of the boarding delay time or the disembark delay time, the travel schedule transmitter 19 further outputs the movement delay time between the stop places among the plurality of stop places in the past to the customer terminal 2 of one existing customer.

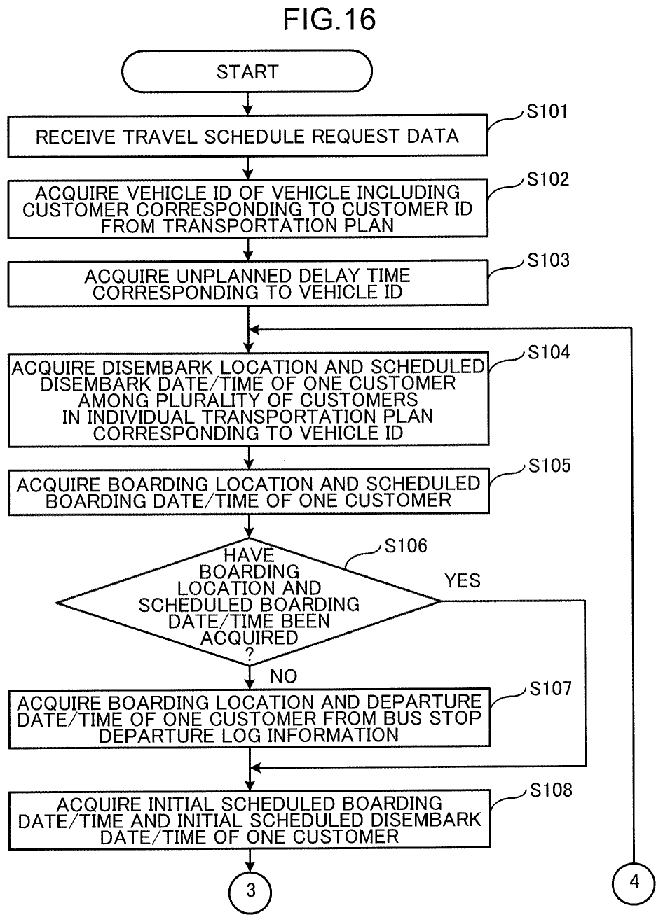

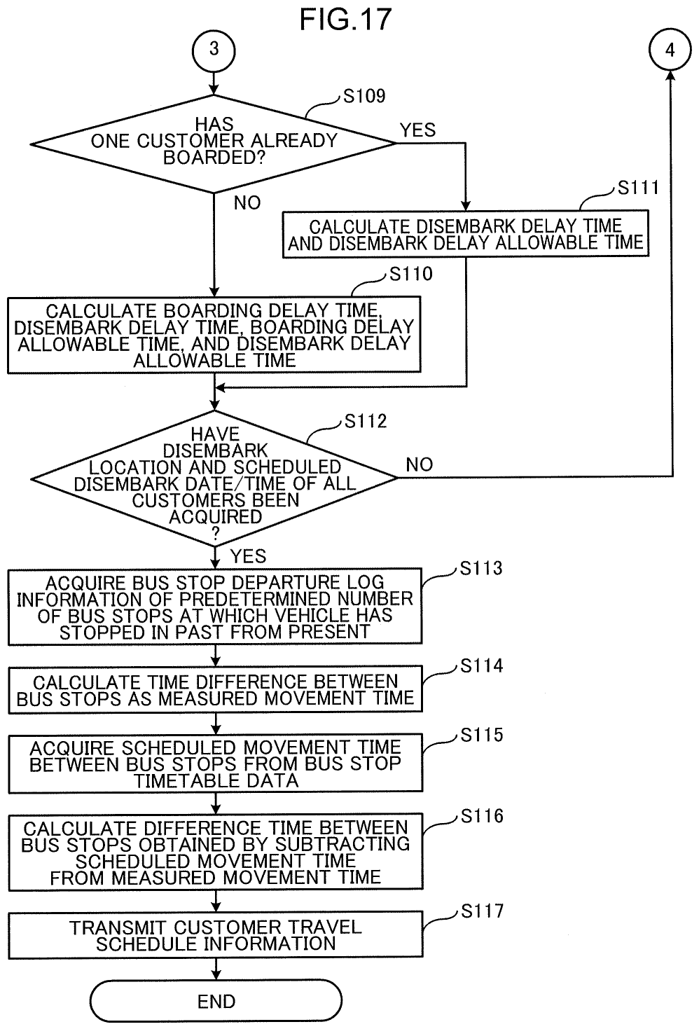

FIG. 16 is a first flowchart for describing the operation of the travel schedule transmitter 19 of the transportation plan creation server 1 in the first modification of the embodiment of the present disclosure, and FIG. 17 is a second flowchart for describing the operation of the travel schedule transmitter 19 of the transportation plan creation server 1 in the first modification of the embodiment of the present disclosure.

The processing of steps S101 to S103 is the same as the processing of steps S81 to S83 illustrated in FIG. 13, and will be omitted from description.

Next, in step S104, the travel schedule transmitter 19 acquires the disembark location and the scheduled disembark date/time of one customer among a plurality of customers in the individual transportation plan corresponding to the acquired vehicle ID from the transportation plan stored in the transportation plan storage part 14.

Next, in step S105, the travel schedule transmitter 19 acquires the boarding location and the scheduled boarding date/time of one customer among a plurality of customers in the individual transportation plan corresponding to the acquired vehicle ID from the transportation plan stored in the transportation plan storage part 14.

Next, in step S106, the travel schedule transmitter 19 determines whether the boarding location and the scheduled boarding date/time of one customer among the plurality of customers in the individual transportation plan corresponding to the acquired vehicle ID has been acquired from the transportation plan stored in the transportation plan storage part 14. When the one customer has already boarded the vehicle, the boarding location of the one customer is deleted from the transportation plan stored in the transportation plan storage part 14, and thus, the boarding location and the scheduled boarding date/time of the one customer are not acquired from the transportation plan.

Here, when it is determined that the boarding location of the one customer and the scheduled boarding date/time have been acquired (YES in step S106), the processing shifts to step S108.

On the other hand, when it is determined that the boarding location and the scheduled boarding date/time of the one customer have not been acquired (NO in step S106), in step S107, the travel schedule transmitter 19 acquires the boarding location and the boarding date/time (departure date/time) of the one customer from the bus stop departure log information stored in the vehicle dynamics log storage part 15. When the one customer has already boarded the vehicle, the travel schedule transmitter 19 acquires the departure date/time of the one customer as the boarding date/time from the bus stop departure log information.

Next, in step S108, the travel schedule transmitter 19 acquires the initial scheduled boarding date/time and the initial scheduled disembark date/time of the one customer associated with the transportation plan stored in the transportation plan storage part 14.

Then, in step S109, the travel schedule transmitter 19 determines whether the one customer has already boarded. Here, when the acquired scheduled boarding date/time or boarding date/time is before the current date/time, the travel schedule transmitter 19 determines that the one customer has already boarded. When the acquired scheduled boarding date/time or boarding date/time is after the current date/time, the travel schedule transmitter 19 determines that the one customer has not boarded.

Here, when it is determined that the one customer has not boarded (NO in step S109), the travel schedule transmitter 19 calculates the boarding delay time, the disembark delay time, the boarding delay allowable time, and the disembark delay allowable time in step S110. The travel schedule transmitter 19 calculates the boarding delay time, the disembark delay time, the boarding delay allowable time, and the disembark delay allowable time on the basis of the above equations (1) to (4).

On the other hand, when it is determined that the one customer has already boarded (YES in step S109), the travel schedule transmitter 19 calculates the disembark delay time and the disembark delay allowable time in step S111. The travel schedule transmitter 19 calculates the disembark delay time and the disembark delay allowable time on the basis of the above equations (2) and (4).

Next, in step S112, the travel schedule transmitter 19 determines whether the disembark location and the scheduled disembark date/time of all the customers in the individual transportation plan corresponding to the acquired vehicle ID have been acquired from the transportation plan stored in the transportation plan storage part 14.

Here, when it is determined that the disembark location and the scheduled disembark date/time of all the customers has not been acquired (NO in step S112), the processing returns to step S104. Then, the travel schedule transmitter 19 acquires the disembark location and the scheduled disembark date/time of another one customer whose disembark location and scheduled disembark date/time have not been acquired among a plurality of customers in the individual transportation plan corresponding to the acquired vehicle ID from the transportation plan stored in the transportation plan storage part 14.

On the other hand, when it is determined that the disembark locations and the scheduled disembark date/time of all the customers have been acquired (YES in step S112), in step S113, the travel schedule transmitter 19 acquires the bus stop departure log information of each bus stop where the vehicle corresponding to the acquired vehicle ID has stopped in a predetermined number of times in the past from the present from the vehicle dynamics log storage part 15.

Next, in step S114, the travel schedule transmitter 19 calculates a time difference of the departure date/time between a predetermined number of bus stops in the past as the measured movement time on the basis of the acquired bus stop departure log information of each bus stop. The measured movement time represents an actual movement time between two bus stops at which the vehicle has stopped.

Next, in step S115, the travel schedule transmitter 19 acquires the scheduled movement time between the predetermined number of bus stops in the past from the bus stop timetable data of the setting data storage part 11.

Next, in step S116, the travel schedule transmitter 19 calculates a difference time between a predetermined number of bus stops in the past obtained by subtracting the scheduled movement time from the measured movement time.

Next, in step S117, the travel schedule transmitter 19 transmits the customer travel schedule information indicating the travel schedule of the customer who has requested the travel schedule to the customer terminal 2. When the customer has not boarded the vehicle, the travel schedule transmitter 19 creates the customer travel schedule information including the vehicle ID of the vehicle that the customer boards, the boarding locations of all the customers included in the individual transportation plan of the vehicle that transports the customer who has requested the travel schedule, the scheduled boarding date/time of all the customers, the information indicating whether each of all the customers has boarded, the boarding delay time of all the customers, the boarding delay allowable time of all the customers, the disembark locations of all the customers, the scheduled disembark date/time of all the customers, the disembark delay time of all the customers, the disembark delay allowable time of all the customers, the unplanned delay time, and the difference time between the predetermined number of bus stops in the past. When the customer has already boarded the vehicle, the travel schedule transmitter 19 creates the customer travel schedule information including the vehicle ID of the vehicle that the customer boards, the boarding locations of all the customers included in the individual transportation plan of the vehicle that transports the customer who has requested the travel schedule, the boarding date/time of all the customers, the information indicating whether each of all the customers has boarded, the disembark locations of all the customers, the scheduled disembark date/time of all the customers, the disembark delay time of all the customers, the disembark delay allowable time of all the customers, the unplanned delay time, and the difference time between the predetermined number of bus stops in the past.

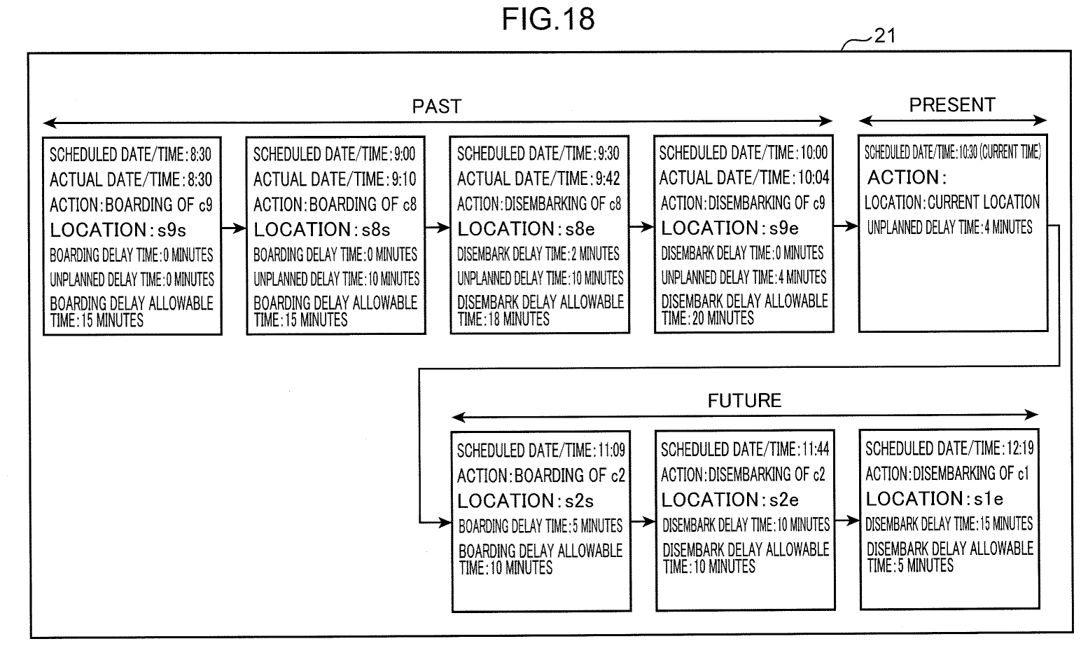

FIG. 18 is a diagram illustrating an example of the travel schedule notification screen displayed on the customer terminal 2 in the first modification of the present embodiment. FIG. 18 illustrates the travel schedule notification screen that presents in time series information related to boarding or disembarking of all the customers who boards the vehicle that transports the customer c1 who has requested the travel schedule.

The customer terminal 2 receives the customer travel schedule information transmitted by the transportation plan creation server 1. When the customer travel schedule information is received, the display part 21 of the customer terminal 2 displays the travel schedule notification screen for notifying the travel schedule of the customer on the basis of the received customer travel schedule information.

When the customer has not boarded the vehicle, the customer travel schedule information includes the vehicle ID of the vehicle that the customer boards, the boarding locations of all the customers included in the individual transportation plan of the vehicle that transports the customer whose travel schedule has been requested, the scheduled boarding date/time of all the customers, the information indicating whether each of all the customers has boarded, the boarding delay time of all the customers, the boarding delay allowable time of all the customers, the disembark locations of all the customers, the scheduled disembark date/time of all the customers, the disembark delay time of all the customers, the disembark delay allowable time of all the customers, the unplanned delay time, and the difference time between the predetermined number of bus stops in the past.

When the customer has already boarded the vehicle, the customer travel schedule information includes the vehicle ID of the vehicle that the customer boards, the boarding locations of all the customers included in the individual transportation plan of the vehicle that transports the customer who has requested the travel schedule, the boarding date/time of all the customers, the information indicating whether each of all the customers has boarded, the disembark locations of all the customers, the scheduled disembark date/time of all the customers, the disembark delay time of all the customers, the disembark delay allowable time of all the customers, the unplanned delay time, and the difference time between the predetermined number of bus stops in the past.

The travel schedule notification screen illustrated in FIG. 18 shows the travel schedule of the customer c1 who has already boarded the vehicle.

In FIG. 18, a scheduled date/time represents the scheduled boarding date/time and the scheduled disembark date/time, an actual date/time represents the departure date/time when each bus stop has actually departed, an action represents an operation (boarding or disembarking) of a customer at each bus stop, and a location represents a bus stop where the customer boards or disembarks.

The travel schedule notification screen includes information related to the current location of the customer c1 who has requested the travel schedule. The information related to the current location includes the current time, the current location of the customer c1, and the unplanned delay time at the current time. The travel schedule notification screen includes information related to boarding of the customer c1 and information related to boarding and disembarking of the other customers c2, c8, and c9 who board the same vehicle as the customer c1. Each piece of the information is displayed in time series. The information related to boarding of the customers c2, c8, and c9 includes the scheduled boarding date/time, the boarding location, the boarding delay time, and the boarding delay allowable time. The information related to disembarking of the customers c1, c2, c8, and c9 includes the scheduled disembark date/time, the disembark location, the disembark delay time, and the disembark delay allowable time. The travel schedule notification screen includes information related to boarding and disembarking of the customers further in the future than the current time and information related to boarding and disembarking of a predetermined number of customers in the past earlier than the current time.

In the first modification of the present embodiment, information related to boarding and disembarking of four customers in the past is displayed in order from the current time. However, the present disclosure is not limited to this display, and information related to boarding and disembarking of two or less customers in the past may be displayed, or information related to boarding and disembarking of five or more customers in the past may be displayed.

The customer terminal 2 calculates the unplanned delay time at each of a predetermined number of bus stops in the past on the basis of the difference time between the predetermined number of bus stops in the past. The information related to boarding and disembarking of the customers c8 and c9 includes the calculated unplanned delay time. For example, when the difference time between the boarding location of the customer c9 and the boarding location of the customer c8 is 10 minutes, the unplanned delay time in the boarding of the customer c8 is 10 minutes. When the difference time between the boarding location of the customer c8 and the disembark location of the customer c8 is 0 minutes, the unplanned delay time in the disembarking of the customer c8 is 10 minutes. When the difference time between the disembark location of the customer c8 and the disembark location of the customer c9 is −6 minutes, the unplanned delay time in the disembarking of the customer c9 is 4 minutes.

Note that the travel schedule notification screen may include information related to boarding of the customer c1. The information related to boarding of the customer c1 may include the scheduled boarding date/time, the boarding location, the boarding delay time, and the boarding delay allowable time.

The information related to the current location, the information related to boarding and disembarking of the customer in the past, and the information related to boarding and disembarking of the customer in the future may be displayed in different modes. That is, the color in the frame that presents each piece of information may be different.

In the first modification of the present embodiment, the travel schedule notification screen that presents in time series the information related to boarding or disembarking of all the customers who board the vehicle that transports the customer who requests the travel schedule is displayed. However, the present disclosure is not limited to this display, and the travel schedule notification screen that presents the information related to boarding or disembarking of all the customers who board the vehicle that transports the customer who has requested the travel schedule on the map may be displayed.

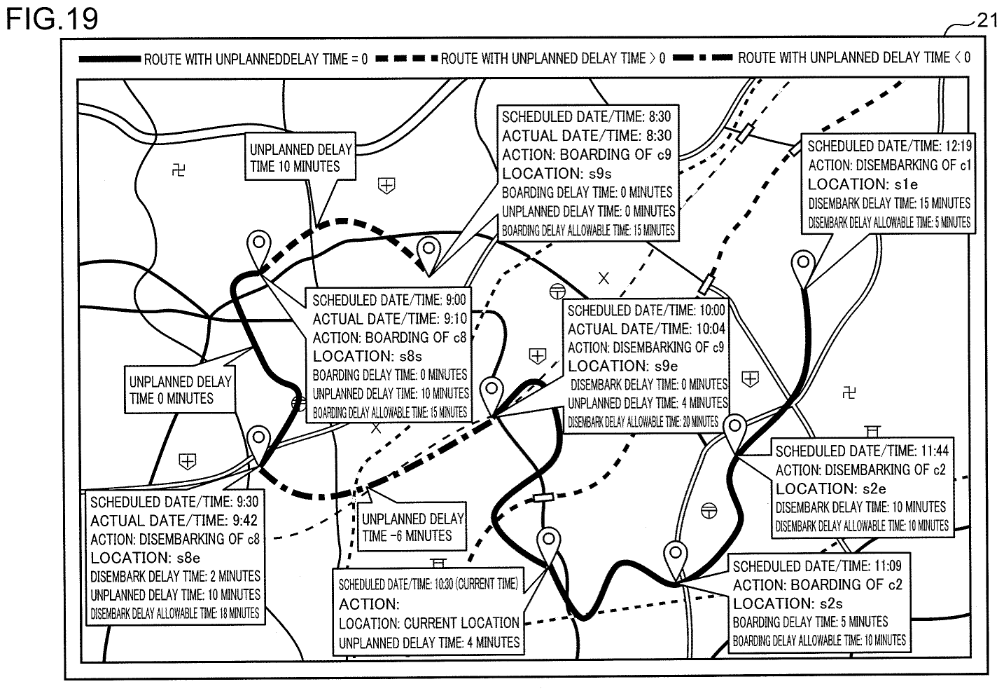

FIG. 19 is a diagram illustrating an example of the travel schedule notification screen displayed on the customer terminal 2 in a second modification of the present embodiment. In FIG. 19, there is displayed the travel schedule notification screen that presents, on a map, information related to boarding or disembarking of all the customers who boards the vehicle that transports the customer c1 who has requested the travel schedule.

The travel schedule notification screen illustrated in FIG. 19 shows the travel schedule of the customer c1 who has already boarded the vehicle.

The travel schedule notification screen includes a map. The travel schedule notification screen includes information related to the current location of the customer c1 who has requested the travel schedule. The information related to the current location includes and displays, on the map, the current time, the current location of the customer c1, and the unplanned delay time at the current time. The travel schedule notification screen includes information related to boarding of the customer c1 and information related to boarding and disembarking of the other customers c2, c8, and c9 who board the same vehicle as the customer c1. Each piece of the information is displayed on the map. The information related to boarding of the customers c2, c8, and c9 includes the scheduled boarding date/time, the boarding location, the boarding delay time, and the boarding delay allowable time. The information related to disembarking of the customers c1, c2, c8, and c9 includes the scheduled disembark date/time, the disembark location, the disembark delay time, and the disembark delay allowable time. The travel schedule notification screen includes information related to boarding and disembarking of the customers further in the future than the current time and information related to boarding and disembarking of a predetermined number of customers in the past earlier than the current time.

In the second modification of the present embodiment, information related to boarding and disembarking of four customers in the past is displayed in order from the current time. However, the present disclosure is not limited to this display, and information related to boarding and disembarking of two or less customers in the past may be displayed, or information related to boarding and disembarking of five or more customers in the past may be displayed.

In the travel schedule notification screen, an icon indicating the current location of the customer c1 and the boarding location and the disembark location of the customers c1, c2, c8, and c9 who board the same vehicle is displayed on the map.

The customer terminal 2 calculates the unplanned delay time at each of a predetermined number of bus stops in the past on the basis of the difference time between the predetermined number of bus stops in the past. The information related to boarding and disembarking of the customers c8 and c9 includes the calculated unplanned delay time. For example, when the difference time between the boarding location of the customer c9 and the boarding location of the customer c8 is 10 minutes, the unplanned delay time in the boarding of the customer c8 is 10 minutes. When the difference time between the boarding location of the customer c8 and the disembark location of the customer c8 is 0 minutes, the unplanned delay time in the disembarking of the customer c8 is 10 minutes. When the difference time between the disembark location of the customer c8 and the disembark location of the customer c9 is −6 minutes, the unplanned delay time in the disembarking of the customer c9 is 4 minutes.

The route of the vehicle between the bus stops is displayed on the map, and the route with the unplanned delay time of 0, the route with the unplanned delay time longer than 0, and the route with the unplanned delay time shorter than 0 are displayed in different modes. That is, the color or shape of each route may be different. The unplanned delay time in each route between each bus stop is displayed.

Note that the travel schedule notification screen may include information related to boarding of the customer c1. The information related to boarding of the customer c1 may include the scheduled boarding date/time, the boarding location, the boarding delay time, and the boarding delay allowable time.

The information related to the current location, the information related to boarding and disembarking of the customer in the past, and the information related to boarding and disembarking of the customer in the future may be displayed in different modes. That is, the color in the frame that presents each piece of information may be different.

A travel schedule notification screen that presents the travel schedule of the existing transportation plan before a change and a travel schedule of the new transportation plan after the change may be displayed.

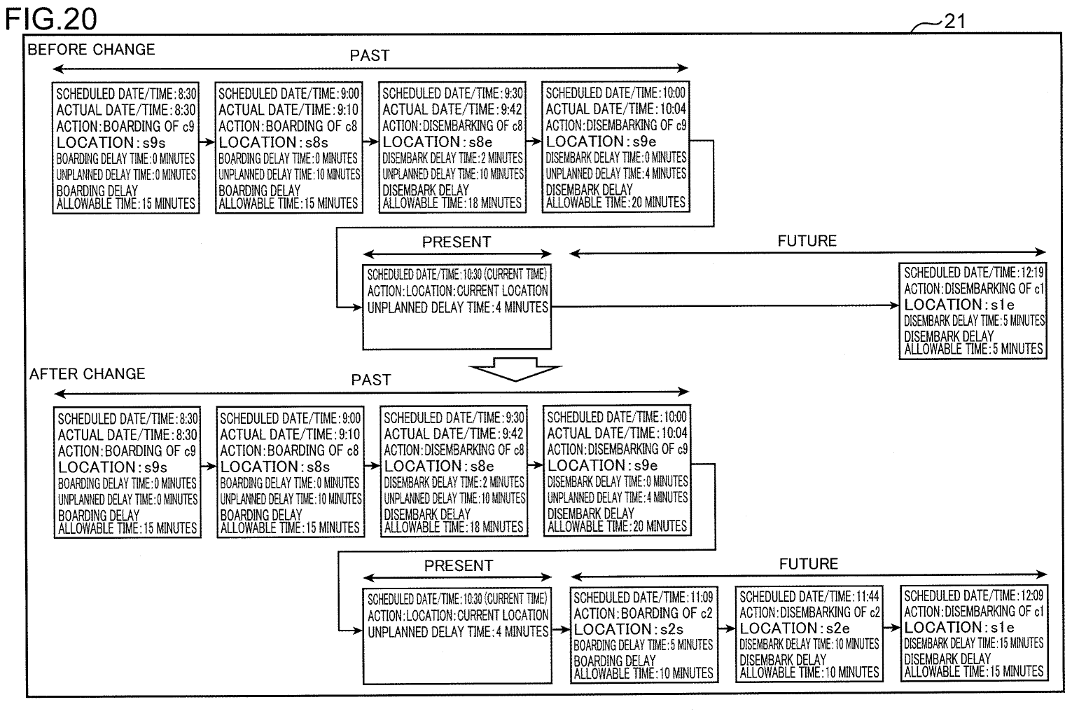

FIG. 20 is a diagram illustrating an example of the travel schedule notification screen displayed on the customer terminal 2 in a third modification of the present embodiment. FIG. 20 illustrates the travel schedule notification screen that presents in time series information related to boarding or disembarking of all the customers who boards the vehicle that transports the customer c1 who has requested the travel schedule.

The travel schedule notification screen illustrated in FIG. 20 shows the travel schedule of the existing transportation plan before the change and the travel schedule of the new transportation plan after the change of the customer c1 who has already boarded the vehicle.

The travel schedule notification screen illustrated in FIG. 20 includes the travel schedule of the existing transportation plan before the change and the travel schedule of the new transportation plan after the change. The customer terminal 2 may store the customer travel schedule information of the existing transportation plan before the change, or the transportation plan creation server 1 may store the customer travel schedule information of the existing transportation plan before the change. The transportation plan creation server 1 may transmit the customer travel schedule information of the existing transportation plan before the change to the customer terminal 2 together with the customer travel schedule information of the new transportation plan after the change.

The travel schedule transmitter 19 further transmits, to the customer terminal 2 of one existing customer, the boarding locations of all the existing customers, the scheduled boarding date/time of all the existing customers, the boarding delay time of all the existing customers, the disembark locations of all the existing customers, the scheduled disembark date/time of all the existing customers, and the disembark delay time of all the existing customers of the vehicle that the one existing customer boards in the existing transportation plan.

FIG. 20 displays the travel schedule of the existing transportation plan before the boarding location and the disembark location of the new customer c2 are inserted into the existing transportation plan, and the travel schedule of the new transportation plan after the boarding location and the disembark location of the new customer c2 are inserted into the existing transportation plan.

The travel schedule notification screen includes information related to the current location of the customer c1 who has requested the travel schedule. The travel schedule notification screen includes information related to boarding of the customer c1 and information related to boarding and disembarking of the other customers c2, c8, and c9 who board the same vehicle as the customer c1. Each piece of the information is displayed in time series. A display content of each piece of information, which is the same as the travel schedule notification screen illustrated in FIG. 18, will not be described.

Note that the travel schedule notification screen may include information related to boarding of the customer c1. The information related to boarding of the customer c1 may include the scheduled boarding date/time, the boarding location, the boarding delay time, and the boarding delay allowable time.

The information related to the current location, the information related to boarding and disembarking of the customer in the past, and the information related to boarding and disembarking of the customer in the future may be displayed in different modes. That is, the color in the frame that presents each piece of information may be different.

The display part 21 of the customer terminal 2 may display in a highlighted manner an item that is a difference between the information related to boarding and disembarking of the customer in the travel schedule of the existing transportation plan before the change and the information related to boarding and disembarking of the customer in the travel schedule of the new transportation plan after the change. The display part 21 may display the characters of the information related to boarding and disembarking of the customer in the travel schedule of the existing transportation plan before the change in black, display the characters of the information related to boarding and disembarking of the new customer in the travel schedule of the new transportation plan after the change in red, and display the characters of the items affected by the addition of the new customer to the existing transportation plan in red.

In the third modification of the present embodiment, the travel schedule notification screen that presents in time series the itinerary of the existing transportation plan before the change and the travel schedule of the new transportation plan after the change is displayed, but the present disclosure is not limited to this display. The travel schedule notification screen that presents the travel schedule of the existing transportation plan before the change and the travel schedule of the new transportation plan after the change on the map may be displayed.

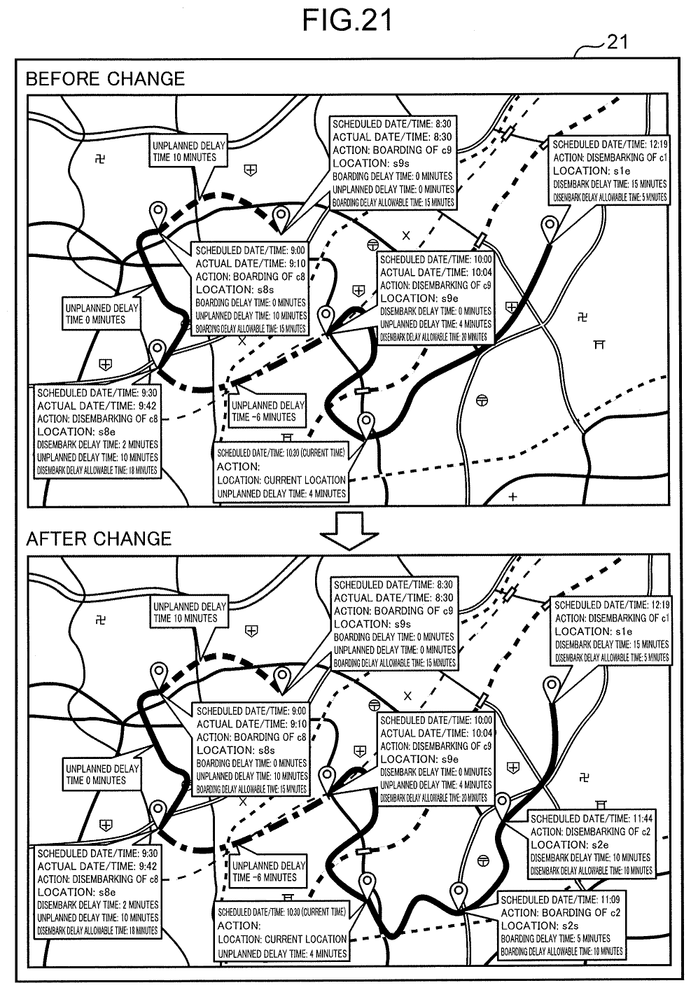

FIG. 21 is a diagram illustrating an example of the travel schedule notification screen displayed on the customer terminal 2 in a fourth modification of the present embodiment. FIG. 21 illustrates the travel schedule notification screen that presents the travel schedule in the existing transportation plan before the change of the customer c1 who has requested the travel schedule and the travel schedule in the new transportation plan after the change of the customer c1 on the map.

The travel schedule notification screen illustrated in FIG. 21 shows the travel schedule of the existing transportation plan before the change and the travel schedule of the new transportation plan after the change of the customer c1 who has already boarded the vehicle.

The travel schedule notification screen illustrated in FIG. 21 includes a map indicating the travel schedule of the existing transportation plan before the change and a map indicating the travel schedule of the new transportation plan after the change. The customer terminal 2 may store the customer travel schedule information of the existing transportation plan before the change, or the transportation plan creation server 1 may store the customer travel schedule information of the existing transportation plan before the change. The transportation plan creation server 1 may transmit the customer travel schedule information of the existing transportation plan before the change to the customer terminal 2 together with the customer travel schedule information of the new transportation plan after the change.

FIG. 21 displays a map indicating the travel schedule of the existing transportation plan before the boarding location and the disembark location of the new customer c2 are inserted into the existing transportation plan, and a map indicating the travel schedule of the new transportation plan after the boarding location and the disembark location of the new customer c2 are inserted into the existing transportation plan.

The travel schedule notification screen includes information related to the current location of the customer c1 who has requested the travel schedule. The travel schedule notification screen includes information related to disembarking of the customer c1 and information related to boarding and disembarking of the other customers c2, c8, and c9 who board the same vehicle as the customer c1. Each piece of the information is displayed on the map. A display content of each piece of information, which is the same as the travel schedule notification screen illustrated in FIG. 19, will not be described.

In the travel schedule notification screen, an icon indicating the current location of the customer c1 and the boarding location and the disembark location of the customers c1, c2, c8, and c9 who board the same vehicle is displayed on the map.

The route of the vehicle between the bus stops is displayed on the map, and the route with the unplanned delay time of 0, the route with the unplanned delay time longer than 0, and the route with the unplanned delay time shorter than 0 are displayed in different modes. That is, the color or shape of each route may be different. The unplanned delay time in each route between each bus stop is displayed.

Note that the travel schedule notification screen may include information related to boarding of the customer c1. The information related to boarding of the customer c1 may include the scheduled boarding date/time, the boarding location, the boarding delay time, and the boarding delay allowable time.

The information related to the current location, the information related to boarding and disembarking of the customer in the past, and the information related to boarding and disembarking of the customer in the future may be displayed in different modes. That is, the color in the frame that presents each piece of information may be different.

The display part 21 of the customer terminal 2 may display in a highlighted manner an item that is a difference between the information related to boarding and disembarking of the customer in the travel schedule of the existing transportation plan before the change and the information related to boarding and disembarking of the customer in the travel schedule of the new transportation plan after the change. The display part 21 may display the characters of the information related to boarding and disembarking of the customer in the travel schedule of the existing transportation plan before the change in black, display the characters of the information related to boarding and disembarking of the new customer in the travel schedule of the new transportation plan after the change in red, and display the characters of the items affected by the addition of the new customer to the existing transportation plan in red.

In the third modification and the fourth modification of the present embodiment, the travel schedule of the existing transportation plan before the change and the travel schedule of the new transportation plan after the change are individually displayed, but the present disclosure is not limited to this display. The changed portion of the travel schedule of the new transportation plan after the change may be displayed in a superimposed manner with the travel schedule of the existing transportation plan before the change.

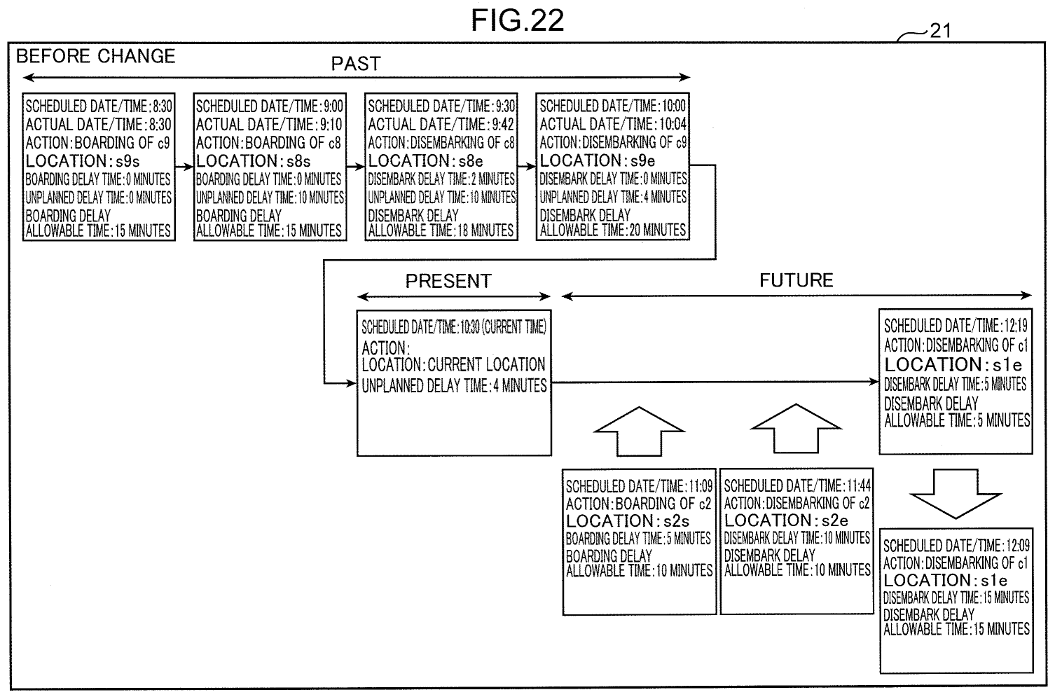

FIG. 22 is a diagram illustrating an example of the travel schedule notification screen displayed on the customer terminal 2 in a fifth modification of the present embodiment. FIG. 22 illustrates the travel schedule notification screen that presents in time series information related to boarding or disembarking of all the customers who boards the vehicle that transports the customer c1 who has requested the travel schedule.

The travel schedule notification screen illustrated in FIG. 22 shows the travel schedule of the existing transportation plan before the change of the customer c1 who has already boarded the vehicle and the changed portion of the travel schedule of the new transportation plan after the change.

The travel schedule notification screen illustrated in FIG. 22 includes the travel schedule of the existing transportation plan before the change and the changed portion of the travel schedule of the new transportation plan after the change. The customer terminal 2 may store the customer travel schedule information of the existing transportation plan before the change, or the transportation plan creation server 1 may store the customer travel schedule information of the existing transportation plan before the change. The transportation plan creation server 1 may transmit the customer travel schedule information of the existing transportation plan before the change to the customer terminal 2 together with the customer travel schedule information of the new transportation plan after the change.

FIG. 22 displays the travel schedule of the existing transportation plan before the boarding location and the disembark location of the new customer c2 are inserted into the existing transportation plan, the information related to the boarding location and the disembark location of the new customer c2, and the information related to the disembarking of the existing customer c1 changed by the new customer c2 being added to the existing transportation plan.

The travel schedule notification screen includes information related to the current location of the customer c1 who has requested the travel schedule. The travel schedule notification screen includes information related to disembarking of the customer c1 and information related to boarding and disembarking of the other customers c8 and c9 who board the same vehicle as the customer c1 in the existing transportation plan before the change. The travel schedule notification screen includes information related to the boarding location and the disembark location of the new customer c2 in the new transportation plan after the change, and information related to disembarking of the existing customer c1 after the change. Each piece of the information is displayed in time series. A display content of each piece of information, which is the same as the travel schedule notification screen illustrated in FIG. 18, will not be described.

The information related to the boarding location and the disembark location of the new customer c2 is displayed together with an arrow at the insertion point in the travel schedule of the existing transportation plan before the change. The information related to disembarking of the existing customer c1 after the change is displayed together with an arrow below the information related to disembarking of the existing customer c1 before the change in the travel schedule of the existing transportation plan before the change.

Note that the travel schedule notification screen may include information related to boarding of the customer c1. The information related to boarding of the customer c1 may include the scheduled boarding date/time, the boarding location, the boarding delay time, and the boarding delay allowable time.

The information related to the current location, the information related to boarding and disembarking of the customer in the past, and the information related to boarding and disembarking of the customer in the future may be displayed in different modes. That is, the color in the frame that presents each piece of information may be different.

The display part 21 of the customer terminal 2 may display in a highlighted manner an item that is a difference between the information related to boarding and disembarking of the customer in the travel schedule of the existing transportation plan before the change and the information related to boarding and disembarking of the customer in the travel schedule of the new transportation plan after the change. The display part 21 may display the characters of the information related to boarding and disembarking of the customer in the travel schedule of the existing transportation plan before the change in black, display the characters of the information related to boarding and disembarking of the new customer in the travel schedule of the new transportation plan after the change in red, and display the characters of the items affected by the addition of the new customer to the existing transportation plan in red.

In the fifth modification of the present embodiment, the travel schedule notification screen that presents in time series the itinerary of the existing transportation plan before the change and the changed portion in the travel schedule of the new transportation plan after the change is displayed, but the present disclosure is not limited to this display. The travel schedule notification screen that presents the travel schedule of the existing transportation plan before the change and the changed portion in the travel schedule of the new transportation plan after the change on the map may be displayed.

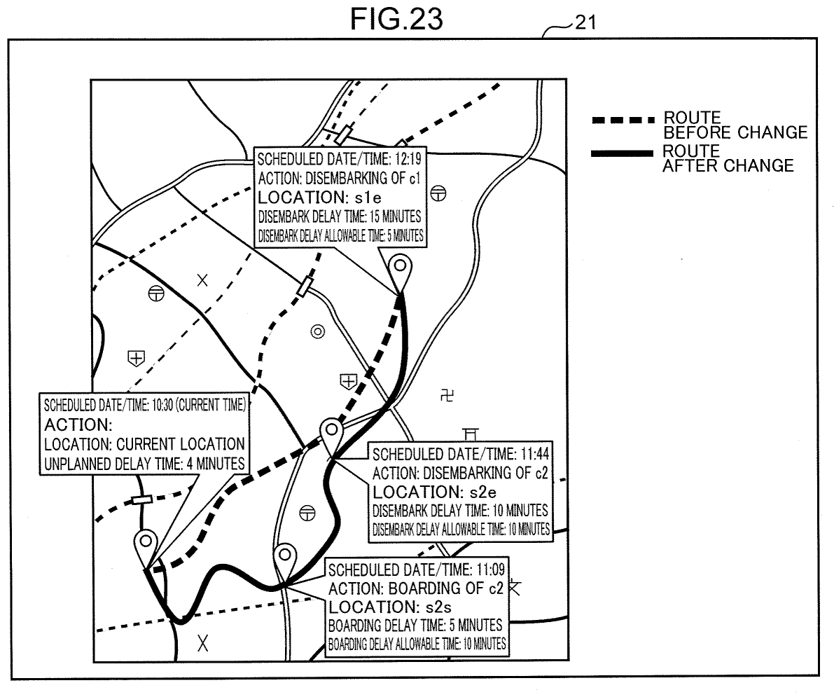

FIG. 23 is a diagram illustrating an example of the travel schedule notification screen displayed on the customer terminal 2 in a sixth modification of the present embodiment. FIG. 23 illustrates the travel schedule notification screen that presents the travel schedule in the existing transportation plan before the change of the customer c1 who has requested the travel schedule and the changed portion of the travel schedule in the new transportation plan after the change of the customer c1 on the map.

The travel schedule notification screen illustrated in FIG. 23 shows the travel schedule of the existing transportation plan before the change of the customer c1 who has already boarded the vehicle and the changed portion of the travel schedule of the new transportation plan after the change.

The travel schedule notification screen illustrated in FIG. 23 includes the map, the travel schedule of the existing transportation plan before the change, and the changed portion of the travel schedule of the new transportation plan after the change. The customer terminal 2 may store the customer travel schedule information of the existing transportation plan before the change, or the transportation plan creation server 1 may store the customer travel schedule information of the existing transportation plan before the change. The transportation plan creation server 1 may transmit the customer travel schedule information of the existing transportation plan before the change to the customer terminal 2 together with the customer travel schedule information of the new transportation plan after the change.

FIG. 23 displays the travel schedule of the existing transportation plan before the boarding location and the disembark location of the new customer c2 are inserted into the existing transportation plan, the information related to the boarding location and the disembark location of the new customer c2, and the information related to the disembarking of the existing customer c1 changed by the new customer c2 being added to the existing transportation plan.

The travel schedule notification screen includes information related to the current location of the customer c1 who has requested the travel schedule. The travel schedule notification screen includes the information related to disembarking of the customer c1 in the existing transportation plan before the change. The travel schedule notification screen includes information related to the boarding location and the disembark location of the new customer c2 in the new transportation plan after the change, and information related to disembarking of the existing customer c1 after the change. Each piece of the information is displayed on the map. A display content of each piece of information, which is the same as the travel schedule notification screen illustrated in FIG. 19, will not be described.

In the travel schedule notification screen, an icon indicating the current location of the customer c1 and the boarding location and the disembark location of the customers c1 and c2 who board the same vehicle is displayed on the map.

The route of the vehicle between the bus stops is displayed on the map, and the route before the change and the route after the change are displayed in different modes. That is, the color or shape of each route may be different.

Note that the travel schedule notification screen may include information related to boarding of the customer c1. The information related to boarding of the customer c1 may include the scheduled boarding date/time, the boarding location, the boarding delay time, and the boarding delay allowable time. The travel schedule notification screen may include the information related to boarding and disembarking of the other customers c8 and c9 who board the same vehicle as the customer c1 and board and disembark before the current time.

The information related to the current location and the information related to boarding and disembarking of the customer in the future may be displayed in different modes. That is, the color in the frame that presents each piece of information may be different.

The display part 21 of the customer terminal 2 may display in a highlighted manner an item that is a difference between the information related to boarding and disembarking of the customer in the travel schedule of the existing transportation plan before the change and the information related to boarding and disembarking of the customer in the travel schedule of the new transportation plan after the change. The display part 21 may display the characters of the information related to boarding and disembarking of the customer in the travel schedule of the existing transportation plan before the change in black, display the characters of the information related to boarding and disembarking of the new customer in the travel schedule of the new transportation plan after the change in red, and display the characters of the items affected by the addition of the new customer to the existing transportation plan in red.

Next, an operation in which the travel schedule transmitter 19 of the transportation plan creation server 1 transmits the travel schedule of the vehicle in an embodiment of the present disclosure will be described.

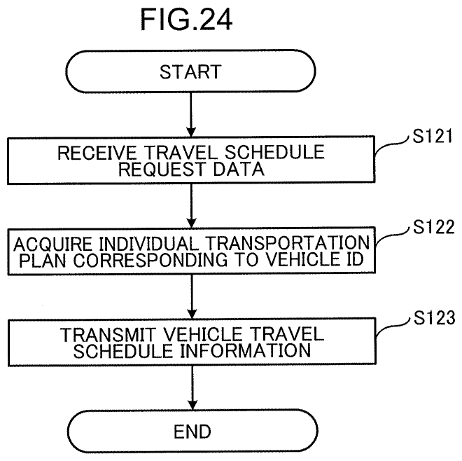

FIG. 24 is a flowchart for describing a vehicle travel schedule transmission operation of the travel schedule transmitter 19 of the transportation plan creation server 1 in an embodiment of the present disclosure.

First, in step S121, the travel schedule transmitter 19 receives travel schedule request data for requesting the travel schedule of the vehicle from the vehicle terminal 3. The travel schedule request data includes the vehicle ID. The vehicle ID is stored in the vehicle terminal 3 in advance. The vehicle terminal 3 periodically transmits the travel schedule request data to the transportation plan creation server 1 as a query. The travel schedule transmitter 19 starts the processing with reception of the travel schedule request data as a trigger.

Next, in step S122, the travel schedule transmitter 19 acquires the individual transportation plan corresponding to the vehicle ID included in the received travel schedule request data from the transportation plan stored in the transportation plan storage part 14.

Next, in step S123, the travel schedule transmitter 19 transmits the vehicle travel schedule information indicating the travel schedule of the vehicle to the vehicle terminal 3. The travel schedule transmitter 19 creates the vehicle travel schedule information including the customer ID of the customer who boards after the current time, the boarding location of the customer, the scheduled boarding date/time of the customer, the boarding delay time of the customer, the boarding delay allowable time of the customer, the customer ID of the customer who disembarks after the current time, the disembark location of the customer, the scheduled disembark date/time of the customer, the disembark delay time of the customer, the disembark delay allowable time of the customer, and the unplanned delay time. The vehicle travel schedule information includes the individual transportation plan of the vehicle corresponding to the vehicle ID included in the travel schedule request data.

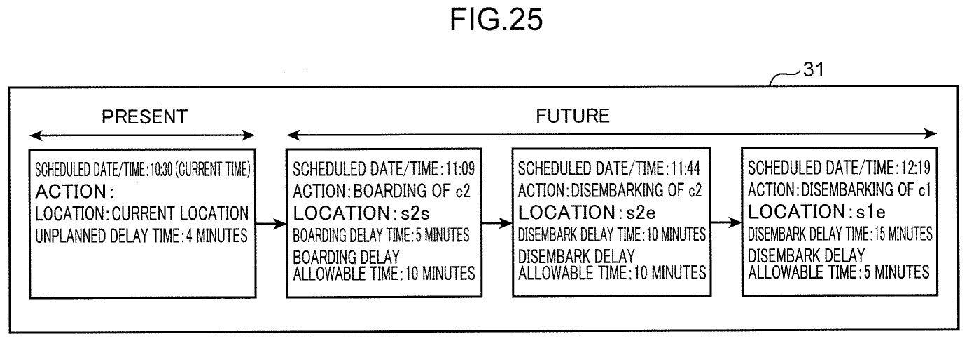

FIG. 25 is a diagram illustrating an example of the travel schedule notification screen displayed on the vehicle terminal 3 in the present embodiment. In FIG. 25, there is displayed the travel schedule notification screen that presents in time series information related to boarding or disembarking of all the customers who, after the current time, boards or disembarks the vehicle that has requested the travel schedule.

The vehicle terminal 3 receives the vehicle travel schedule information transmitted by the transportation plan creation server 1. When the vehicle travel schedule information is received, the display part 31 of the vehicle terminal 3 displays the travel schedule notification screen for notifying the travel schedule of the vehicle on the basis of the received vehicle travel schedule information.

The vehicle travel schedule information includes the customer ID of the customer who boards after the current time, the boarding location of the customer, the scheduled boarding date/time of the customer, the boarding delay time of the customer, the boarding delay allowable time of the customer, the customer ID of the customer who disembarks after the current time, the disembark location of the customer, the scheduled disembark date/time of the customer, the disembark delay time of the customer, the disembark delay allowable time of the customer, and the unplanned delay time.

The travel schedule notification screen illustrated in FIG. 25 shows the travel schedule of the vehicle that the customer c1 has already boarded.

In FIG. 25, a scheduled date/time represents the scheduled boarding date/time and the scheduled disembark date/time, an action represents an operation (boarding or disembarking) of a customer at each bus stop, and a location represents a bus stop where the customer boards or disembarks.

The travel schedule notification screen includes information related to the current location of the vehicle that has requested the travel schedule. The information related to the current location includes the current time, the current location of the vehicle, and the unplanned delay time at the current time. The travel schedule notification screen includes information related to boarding of the customer c1 and information related to boarding and disembarking of another customer c2 who boards the same vehicle as the customer c1. Each piece of the information is displayed in time series. The information related to boarding of the customer c2 includes the scheduled boarding date/time, the boarding location, the boarding delay time, and the boarding delay allowable time. The information related to disembarking of the customers c1 and c2 includes the scheduled disembark date/time, the disembark location, the disembark delay time, and the disembark delay allowable time. The travel schedule notification screen includes information related to boarding and disembarking of the customer further in the future than the current time.

Note that the information related to the current location and the information related to boarding and disembarking of the customer in the future may be displayed in different modes. That is, the color in the frame that presents each piece of information may be different.

In the present embodiment, the travel schedule notification screen that presents in time series the information related to boarding or disembarking of all the customers who board the vehicle that has requested the travel schedule is displayed. However, the present disclosure is not limited to this display, and the travel schedule notification screen that presents the information related to boarding or disembarking of all the customers who board the vehicle that has requested the travel schedule on the map may be displayed.

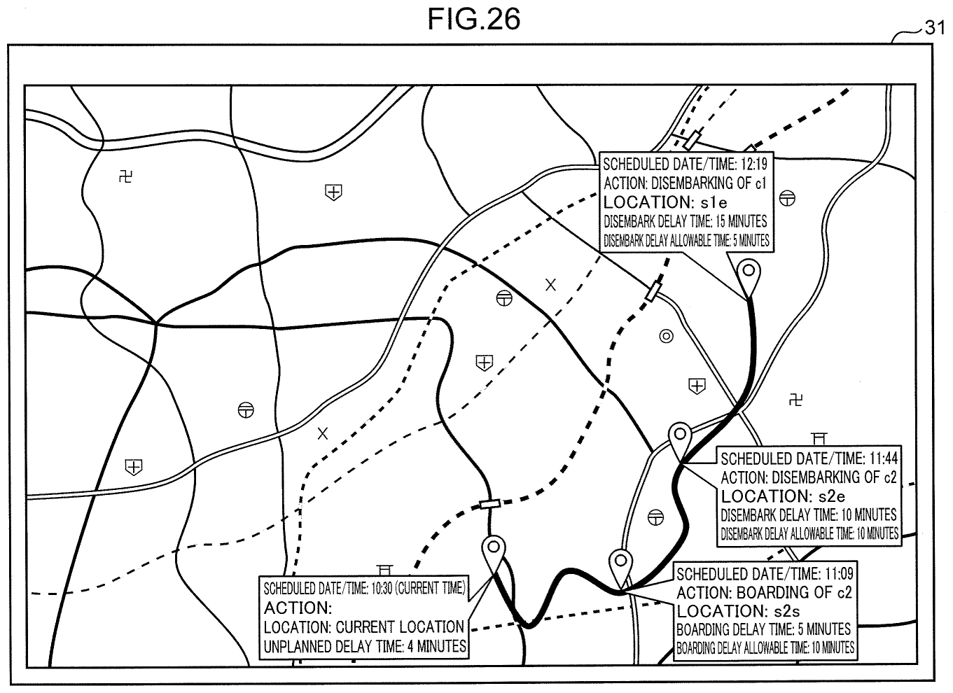

FIG. 26 is a diagram illustrating an example of the travel schedule notification screen displayed on the vehicle terminal 3 in a seventh modification of the present embodiment. In FIG. 26, there is displayed the travel schedule notification screen that presents, on the map, information related to boarding or disembarking of all the customers who, after the current time, boards or disembarks the vehicle that has requested the travel schedule.

The travel schedule notification screen illustrated in FIG. 26 shows the travel schedule of the vehicle that the customer c1 has already boarded.

The travel schedule notification screen includes a map. The travel schedule notification screen includes information related to the current location of the vehicle that has requested the travel schedule. The information related to the current location includes and displays, on the map, the current time, the current location of the vehicle, and the unplanned delay time at the current time. The travel schedule notification screen includes information related to boarding of the customer c1 and information related to boarding and disembarking of another customer c2 who boards the same vehicle as the customer c1. Each piece of the information is displayed on the map. The information related to boarding of the customer c2 includes the scheduled boarding date/time, the boarding location, the boarding delay time, and the boarding delay allowable time. The information related to disembarking of the customers c1 and c2 includes the scheduled disembark date/time, the disembark location, the disembark delay time, and the disembark delay allowable time. The travel schedule notification screen includes information related to boarding and disembarking of the customer further in the future than the current time.

In the travel schedule notification screen, an icon indicating the current location of the vehicle and the boarding location and the disembark location of the customers c1 and c2 who board the same vehicle is displayed on the map.

The route of the vehicle between the bus stops is displayed on the map.

The information related to the current location and the information related to boarding and disembarking of the customer in the future may be displayed in different modes. That is, the color in the frame that presents each piece of information may be different.

Note that, in each of the above embodiments, each constituent element may be implemented by including dedicated hardware or by executing a software program suitable for each constituent element. Each constituent element may be implemented by a program execution part, such as a CPU or a processor, reading and executing a software program recorded in a recording medium such as a hard disk or a semiconductor memory. A program may be recorded onto a recording medium and transferred or transferred via a network, so that the program is performed by another independent computer system.

Some or all functions of the device according to the embodiment of the present disclosure are implemented as large scale integration (LSI), which is typically an integrated circuit. These may be individually integrated into one chip, or may be integrated into one chip so as to include some or all of these. Circuit integration is not limited to LSI, and may be implemented by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Some or all functions of the device according to the embodiments of the present disclosure may be implemented by a processor such as a CPU executing a program.

All numbers used above are illustrated to specifically describe the present disclosure, and the present disclosure is not limited to the illustrated numbers.

The order in which steps illustrated in the above flowchart are executed is for specifically describing the present disclosure, and may be any order other than the above order as long as a similar effect is obtained. Some of the above steps may be executed simultaneously (in parallel) with other steps.

The technique according to the present disclosure can present, to an existing customer assigned to an existing transportation plan, delay time generated by incorporating a transportation request of a new customer into the existing transportation plan, and thus is useful as a technique for creating a transportation plan for transporting a plurality of customers by a plurality of vehicles.

1. An information processing method in a computer, the method comprising:
acquiring a transportation request including a desired boarding date/time of a new customer who desires to be transported by a vehicle;
acquiring an existing transportation plan including a boarding date/time and a disembark date/time of an existing customer;
calculating at least one of boarding delay time and disembark delay time indicating time delayed from at least one of a scheduled boarding date/time and a scheduled disembark date/time of one existing customer in the existing transportation plan by incorporating the transportation request into the existing transportation plan; and
outputting at least one of the boarding delay time and the disembark delay time.

2. The information processing method according to claim 1, wherein the transportation request further includes customer identification information, a boarding location, and a disembark location.

3. The information processing method according to claim 1, wherein
the existing transportation plan is a plan in which boarding locations and disembark locations of a plurality of existing customers are arranged in chronological order in a plurality of vehicles, and
the transportation request is incorporated into the existing transportation plan by inserting the boarding location and the disembark location of the new customer into the existing transportation plan based on the transportation request.

4. The information processing method according to claim 1, further comprising:
calculating movement delay time that is a difference between measured movement time required for one vehicle that the one existing customer boards to move from a first spot to a second spot included in the existing transportation plan, and scheduled movement time between the first spot and the second spot, the scheduled movement time having been set in advance,
wherein in the output of at least one of the boarding delay time and the disembark delay time, the movement delay time is further outputted.

5. The information processing method according to claim 1, further comprising:
acquiring boarding delay upper limit time indicating an upper limit of the boarding delay time from the scheduled boarding date/time; and
calculating boarding delay allowable time that is obtained by subtracting the boarding delay time from the boarding delay upper limit time,
wherein in the output of at least one of the boarding delay time and the disembark delay time, the boarding delay allowable time is further outputted with the boarding delay time.

6. The information processing method according to claim 1, further comprising:
acquiring disembark delay upper limit time indicating an upper limit of the disembark delay time from the scheduled disembark date/time; and
calculating disembark delay allowable time that is obtained by subtracting the disembark delay time from the disembark delay upper limit time,
wherein in the output of at least one of the boarding delay time and the disembark delay time, the disembark delay allowable time is further outputted with the disembark delay time.

7. The information processing method according to claim 1, further comprising:
acquiring a travel schedule request for requesting a travel schedule of the one existing customer from a terminal of the one existing customer,
wherein in the output of at least one of the boarding delay time and the disembark delay time, a boarding location of the one existing customer, a scheduled boarding date/time of the one existing customer, the boarding delay time of the one existing customer, a disembark location of the one existing customer, a scheduled disembark date/time of the one existing customer, and the disembark delay time of the one existing customer in a new transportation plan in which the transportation request is incorporated into the existing transportation plan are outputted to the terminal of the one existing customer.

8. The information processing method according to claim 7, further comprising:
determining whether or not the one existing customer has already boarded the vehicle at a current date/time,
wherein in the output of at least one of the boarding delay time and the disembark delay time, in a case where it is determined that the one existing customer has already boarded the vehicle at the current date/time, information indicating that the one existing customer has already boarded the vehicle is further outputted to the terminal of the one existing customer.

9. The information processing method according to claim 1, further comprising:
acquiring a travel schedule request for requesting a travel schedule of the one existing customer from a terminal of the one existing customer,
wherein in the output of at least one of the boarding delay time and the disembark delay time, boarding locations of all existing customers and the new customer of the vehicle that the one existing customer boards, scheduled boarding date/time of all the existing customers and the new customer, the boarding delay time of all the existing customers and the new customer, disembark locations of the all the existing customers and the new customer, and scheduled disembark date/time of all the existing customers and the new customer, and the disembark delay time of all the existing customers and the new customer in a new transportation plan in which the transportation request is incorporated into the existing transportation plan are outputted to the terminal of the one existing customer.

10. The information processing method according to claim 9, further comprising:
calculating a time difference as measured movement time, the time difference being a difference between each of departure date/time of the vehicle at a plurality of stop places that are places where other existing customers who board the same vehicle as the one existing customer boarded and disembarked from the vehicle in the past, and a departure date/time of the vehicle at a stop place one before each of the plurality of stop places;
acquiring scheduled movement time set in advance, the scheduled movement time being time between each of the plurality of stop places and the stop place one before each of the plurality of stop places; and
calculating movement delay time that is a difference between the measured movement time and the scheduled movement time between the respective stop places among the plurality of stop places,
wherein in the output of at least one of the boarding delay time and the disembark delay time, the movement delay time between the respective stop places among the plurality of stop places in the past is further outputted to the terminal of the one existing customer.

11. The information processing method according to claim 9, wherein in the output of at least one of the boarding delay time and the disembark delay time, boarding locations of all existing customers of the vehicle that the one existing customer boards, scheduled boarding date/time of all the existing customers, the boarding delay time of all the existing customers, disembark locations of all the existing customers, scheduled disembark date/time of all the existing customers, and the disembark delay time of all the existing customers in the existing transportation plan are further outputted to the terminal of the one existing customer.

12. An information processing device comprising:
a transportation request acquisition part that acquires a transportation request including a desired boarding date/time of a new customer who desires to be transported by a vehicle;
an existing transportation plan acquisition part that acquires an existing transportation plan including a boarding date/time and a disembark date/time of an existing customer;
a calculator that calculates at least one of boarding delay time and disembark delay time indicating time delayed from at least one of a scheduled boarding date/time and a scheduled disembark date/time of one existing customer in the existing transportation plan by incorporating the transportation request into the existing transportation plan; and
an output part that outputs at least one of the boarding delay time and the disembark delay time.

13. A non-transitory computer readable recording medium storing an information processing program that causes a computer to function so as to:
acquire a transportation request including a desired boarding date/time of a new customer who desires to be transported by a vehicle;
acquire an existing transportation plan including a boarding date/time and a disembark date/time of an existing customer;
calculate at least one of boarding delay time and disembark delay time indicating time delayed from at least one of a scheduled boarding date/time and a scheduled disembark date/time of one existing customer in the existing transportation plan by incorporating the transportation request into the existing transportation plan; and
output at least one of the boarding delay time and the disembark delay time.
